(19) United States
(12) Patent Application Publication
(10) Pub. No.: US 2026/0289478 A1
(43) Pub. Date: Sep. 24, 2026

(54) CONTINUOUS MONITORING PERFORMANCE ENGINE

(71) Applicant: PwC Product Sales LLC, New York, NY (US)

(72) Inventors: Saurabh SARBALIYA, Delray Beach, FL (US); Adam STAFFORD, Scottsdale, AZ (US)

(73) Assignee: PwC Product Sales LLC, New York, NY (US)

(21) Appl. No.: 19/573,581

(22) Filed: Mar. 20, 2026

Related U.S. Application Data
(60) Provisional application No. 63/775,840, filed on Mar. 21, 2025.

(51) Int. Cl. G06Q 10/067; G06Q 10/04

(52) U.S. Cl. CPC G06Q 10/0674; G06Q 10/04

(57) ABSTRACT

A method for optimizing one or more enterprise processes comprises ingesting enterprise data into a database; identifying one or more opportunities for improving one or more enterprise processes; executing one or more process optimizations using one or more process optimization models, wherein executing the one or more process optimizations comprises: inputting the ingested enterprise data into the one or more process optimization models trained to generate recommended process adjustments, outputting one or more recommended process adjustments generated using the one or more process-optimization models, and adjusting the one or more processes based on the one or more recommended adjustments.

### CROSS-REFERENCE TO RELATED APPLICATIONS

This application claims the benefit of U.S. Provisional Application No. 63/775,840, filed Mar. 21, 2025, the entire contents of which are incorporated herein by reference.

### FIELD

This disclosure relates generally to artificial intelligence and more specifically to interactive agentic AI systems and methods.

### BACKGROUND

Enterprises today are confronted with a multitude of technical challenges that impede their ability to optimize operational processes effectively. These challenges include managing vast amounts of data from disparate sources, ensuring data integrity and accessibility, and deriving actionable insights from complex datasets. Additionally, enterprises must contend with the dynamic nature of market conditions, which requires adaptive strategies for pricing, inventory management, procurement, maintenance, and many other enterprise processes. Traditional systems often lack the capability to process data in real-time, simulate potential outcomes effectively and efficiently, and implement process improvements autonomously, leading to inefficiencies and missed opportunities. Moreover, conventional enterprise systems often silo data and processes (e.g., enterprise resource planning (ERP) enabled processes, customer relationship management (CRM) enabled processes, human resources information system (HRIS) data and enabled processes, etc.) such that no single system can provide comprehensive end-to-end enterprise process improvement.

### SUMMARY

Disclosed herein are systems, methods, devices, and non-transitory computer-readable storage media for improving enterprise processes using agentic artificial intelligence (e.g., “AI agents”) and machine learning. An AI agent, as used herein, may refer to an AI-powered software module. An AI agent may include or have access to one or more generative AI models (e.g., large language models (LLMs), generative adversarial networks (GANs), etc.), one or more process optimization machine learning models trained for particular enterprise process optimizations, memory, and/or other tools such as application programming interfaces (APIs), data visualization software, statistical analysis packages, and/or optimization algorithms.

According to the techniques disclosed herein, one or more AI agents may utilize enterprise data (e.g., enterprise resource planning (ERP) data) to optimize enterprise processes with one or more process optimization machine learning models. The one or more process optimization machine learning models may output actionable recommendations usable by the AI agents to simulate process adjustments using generative AI models, recommend adjustments to users, and/or autonomously execute adjustments to enterprise processes. The one or more AI agents may deploy (e.g., autonomously or in response to user inputs) adjustments to enterprise processes, such as pricing, preventative maintenance, inventory, procurement, etc., to enable enhanced enterprise operational efficiency.

In some examples, the one or more AI agents may operate according to a “sense, think, act” framework. In the sense phase, the AI agents may ingest and monitor enterprise data to identify performance degradation or opportunities for improvement. In the think phase, the AI agents may process the sensed data using process optimization models (e.g., specialized machine learning models, system dynamics models) to identify opportunities, generate recommendations, and simulate potential outcomes. In the act phase, the AI agents may recommend adjustments to users and/or autonomously execute adjustments to enterprise processes. In some examples, any one or more of the characteristics of any one or more of the systems, methods, and/or computer-readable storage mediums described herein may be combined, in whole or in part, with one another and/or with any other features or characteristics described elsewhere herein.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying drawings of which:

FIG. 1 illustrates aspects of an exemplary system for optimizing enterprise processes using generative and agentic artificial intelligence according to some examples.

FIG. 2A illustrates aspects of an exemplary process for optimizing enterprise processes using generative and agentic artificial intelligence according to some examples.

FIG. 2B illustrates aspects of an exemplary process for executing, using one or more process optimization models of one or more AI agents, one or more process optimizations, according to some examples.

FIG. 2C illustrates aspects of an exemplary process for adjusting one or more processes based on the one or more process adjustments generated using one or more AI agents according to some examples.

FIG. 3 illustrates aspects of an exemplary graphical user interface for optimizing enterprise processes using generative and agentic artificial intelligence according to some examples.

FIG. 4 illustrates additional aspects of an exemplary graphical user interface for optimizing enterprise processes using generative and agentic artificial intelligence according to some examples.

FIG. 5 illustrates additional aspects of an exemplary graphical user interface for optimizing enterprise processes using generative and agentic artificial intelligence according to some examples.

FIG. 6 illustrates additional aspects of an exemplary graphical user interface for optimizing enterprise processes using generative and agentic artificial intelligence according to some examples.

FIG. 7 illustrates additional aspects of an exemplary graphical user interface for optimizing enterprise processes using generative and agentic artificial intelligence according to some examples.

FIG. 8 illustrates additional aspects of an exemplary graphical user interface for optimizing enterprise processes using generative and agentic artificial intelligence according to some examples.

FIG. 9 illustrates additional aspects of an exemplary graphical user interface for optimizing enterprise processes using generative and agentic artificial intelligence according to some examples.

FIG. 10 illustrates additional aspects of an exemplary graphical user interface for optimizing enterprise processes using generative and agentic artificial intelligence according to some examples.

FIG. 11 illustrates aspects of an exemplary process for training one or more process optimization machine learning models according to some examples.

FIG. 12 illustrates aspects of an exemplary computing device according to some examples.

FIG. 13 illustrates aspects of an exemplary method for optimizing enterprise processes according to some examples.

FIG. 14 illustrates aspects of an exemplary process for training a GAN according to some examples.

FIG. 15 illustrates aspects of an exemplary process for optimizing enterprise processes according to some examples.

FIGS. 16A-16D illustrate aspects of a graphical user interface for monitoring AI agent performance and managing interactions between AI agents and human users according to some examples.

FIGS. 17A-17B illustrate aspects of a graphical user interface for managing instructions and summaries associated with a buyer-focused AI agent according to some examples.

FIGS. 18A-18D illustrate aspects of a graphical user interface for prompting AI agents to execute enterprise functions using natural language inputs and for validating and submitting AI-generated outputs according to some examples.

### DETAILED DESCRIPTION

Disclosed herein are systems, methods, devices, and non-transitory computer-readable storage media for improving enterprise processes using agentic artificial intelligence (e.g., “AI agents”) and machine learning. As described above, an AI agent, as used herein, may refer to an AI-powered software module. An AI agent may include or have access to one or more generative machine learning models, such as large language models (LLMs), generative adversarial networks (GANs), or other generative AI models, one or more process optimization machine learning models trained for particular enterprise process optimizations, memory, and/or other tools such as application programming interfaces (APIs), data visualization software, statistical analysis packages, and/or optimization algorithms. The one or more AI agents disclosed herein may process enterprise data to recommend adjustments to and/or autonomously modify enterprise processes to enable enhanced efficiencies, profits, and otherwise improve the overall performance of an enterprise. In some examples, the one or more AI agents may operate according to a “sense, think, act” framework. In the sense phase, the AI agents may ingest and monitor enterprise data to identify performance degradation or opportunities for improvement. In the think phase, the AI agents may process the sensed data using process optimization models (e.g., specialized machine learning models, system dynamics models) to identify opportunities, generate recommendations, and simulate potential outcomes. In the act phase, the AI agents may recommend adjustments to users and/or autonomously execute adjustments to enterprise processes.

An exemplary system may ingest enterprise data, optionally including enterprise resource planning (ERP), customer relationship management (CRM) data, human resources information system (HRIS) data, and/or other enterprise data from one or more sources. The system may additionally ingest external data (e.g., public financial disclosures, etc.). The system may determine enterprise performance metrics (e.g., revenues, equipment failure rates, inventory turnover, etc.) and compare those metrics against one or more performance thresholds and/or criteria. The system may identify areas of performance degradation, such as enterprise processes (e.g., pricing, maintenance, inventory management, procurement, etc.) that are performing below a performance threshold, fail to satisfy a performance criteria (e.g., a classification criteria), and/or that are trending toward underperformance (e.g., decreasing sales, increasing equipment failures, etc.). The system may indicate such areas of performance degradation to users of the system and/or directly to one or more AI agents. In some examples, either in response to user instruction or autonomously, the one or more AI agents may process enterprise data to identify, recommend, and/or execute modifications to enterprise processes to improve the performance of that process by a measurable metric relative to the one or more respective performance thresholds and/or criteria. The performance thresholds and/or criteria may include industry benchmarks and/or predictive criteria indicating predicted performance criteria in different areas based on how the respective area (e.g., sales) is expected to evolve in the future. The performance thresholds and/or criteria may thus adapt to evolving operational contexts (e.g., thresholds may change based on measured and/or predicted business and industry conditions, such as the predicted impact of agentic AI in a given industry or aspect of an industry).

In some examples, one or more AI agents may evaluate enterprise processes using enterprise data, optionally including enterprise resource planning (ERP), customer relationship management (CRM) data, human resources information system (HRIS) data, and/or other enterprise data. to identify opportunities for improvement. The AI agents may leverage generative AI models (e.g., LLMs) and/or one or more process optimization machine learning models to identify optimal enterprise process parameters (e.g., pricing, maintenance schedules, etc.). The AI agents may leverage process optimization machine learning models, which may be trained to analyze complex enterprise datasets, identify patterns that inform process optimization strategies, and output recommended process parameters, including adjustments to such parameters (e.g., pricing, procurement, etc.). Enterprise process simulations may involve utilizing one or more generative AI models that forecast outcomes based on different scenarios (e.g., different pricing strategies, different maintenance schedules, etc.), optionally allowing enterprises to evaluate potential adjustments before implementation. Enterprise process simulations may simulate a plurality of interrelated processes included in an enterprise, which can include the processes optimized using the process optimization models disclosed herein. In some examples, a GUI may provide an interactive platform for users to explore insights, compare scenarios, and make informed decisions. In some examples, one or more AI agents may autonomously execute enterprise process adjustments, enabling seamless periodic (or continuous) optimization of any or all enterprise processes.

The AI agents, generative AI models, and/or process optimization machine learning models disclosed according to the examples herein may undergo continuous refinement. Exemplary systems may track enterprise performance metrics following the implementation of enterprise process adjustments and may continuously/iteratively refine the AI agents, generative AI models, and/or process optimization machine learning models to ensure that the AI agents, generative AI models, and/or process optimization machine learning models remain aligned with the evolving needs of the enterprise and consistently improve performance outcomes. For example, once an AI agent implements adjustments to an enterprise process, the system may continue monitoring performance metrics and other relevant metrics to assess the impact of these adjustments. This monitoring may involve collecting real-time data from various enterprise systems, such as sales figures, production rates, inventory levels, customer satisfaction, etc. The system may employ data analytics tools to analyze this data, identifying trends and deviations from expected performance levels.

Based on the analysis of post-adjustment performance metrics, the AI agents can identify areas where the adjustments have succeeded and areas that require further optimization. This feedback loop may allow the AI agents to refine their decision-making algorithms and update the process optimization machine learning models accordingly. For instance, if a pricing adjustment leads to increased sales but reduced profit margins, the AI agents may adjust their pricing strategy to optimize both revenue and profitability. The continuous refinement process may also involve retraining the process optimization machine learning models with the updated (e.g., more recent, real-time, etc.) data, including enterprise data and/or external data (e.g., models used by an AI agent to optimize pricing may be trained using data including competitor pricing data, models used by an AI agent to optimize preventative maintenance may be trained using data including real-time weather data). This retraining may ensure that the models incorporate new patterns and insights, enhancing their predictive accuracy and relevance. By continuously refining the AI agents and specialized machine learning models, the system may adapt to changing business conditions and market dynamics, ensuring sustained performance improvements. This capability may empower enterprises to maintain a competitive edge by proactively addressing challenges and capitalizing on opportunities as they arise.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear from the description below. In addition, the present invention is not described with reference to any particular programming language. It will be appreciated that a variety of programming languages may be used to implement the teachings of the present disclosure as described herein.

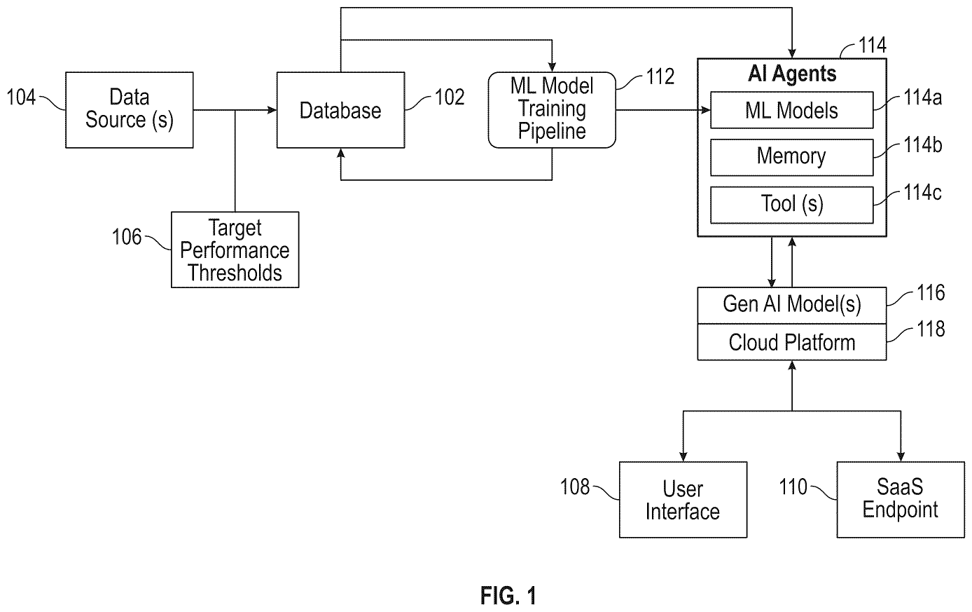

FIG. 1 illustrates an exemplary system 100 for improving one or more enterprise processes using agentic artificial intelligence (i.e., “AI agents”). System 100 may enable one or more AI agents to simulate enterprise processes, generate actionable insights, and automatically (or in response to user inputs) implement enterprise process improvements, thereby driving enhanced operational efficiency and strategic decision-making. System 100 may include one or more electronic devices implementing one or more software programs. System 100 may include or be connected to a database 102, user interface 108, SaaS endpoints 110, a machine learning model training pipeline 112, and one or more AI agents 114.

System 100 may ingest data, including enterprise resource planning (ERP) data, from one or more data sources 104. The one or more AI agents 114 may identify (e.g., autonomously and/or in response to user inputs) areas of performance degradation (e.g., underperforming enterprise processes) using the data ingested from the one or more data sources 104. The one or more areas of performance degradation may be identified based on a comparison between one or more measured ERP performance metrics included in or determined using the data ingested by system 100 relative to one or more threshold ERP performance metrics and/or performance criteria. The one or more AI agents 114 may determine adjustments to improve (e.g., optimize) such processes, for instance, by simulating enterprise processes and/or adjustments to enterprise processes using one or more process optimization machine learning models 114a and generative AI models 116. For example, the system 100 may be configured to determine whether pricing for products or services are generating revenues or profits that meet predicted performance levels. The one or more AI agents 114 may determine, recommend, and/or autonomously execute pricing adjustments to improve underperforming revenue streams relative to threshold performance values. System 100 may enable users (and/or the AI agents 114 themselves) to deploy such adjustments in the “real-world” to improve enterprise performance. The one or more AI agents may also monitor and recommend adjustments to and/or automatically adjust other enterprise processes including preventative maintenance schedules, inventory, procurement processes, and/or any other enterprise processes to seamlessly improve (e.g., optimize) enterprise performance.

The one or more AI agents 114 may include or have access to the one or more generative AI models (e.g., LLMs) 116 and one or more process optimization machine learning models 114a, a memory 114b, and/or other tools 114c. The one or more AI agents 114 may leverage generative AI models 116 and/or process optimization machine learning models 114a, memory 114b, and/or other tools 114c, to execute complex enterprise process optimizations and simulations. The AI agents 114 may identify relevant enterprise data for a given process and input the relevant enterprise data into one or more process optimization machine learning models 114a. This data may include historical performance metrics, market trends, customer behavior, and operational parameters. The one or more process optimization machine learning models 114a may process this data to identify latent structures and correlations and may generate recommendations(e.g., recommended process adjustments, insights regarding different process configurations, such as predicted machine failure rates or predicted profits, etc.) that can be simulated using generative AI models 116 and used to optimize enterprise processes (e.g., determining optimal pricing for profits, etc.).

The one or more AI agents 114 may use one or more process optimization machine learning models 114a tailored to a given enterprise process optimization (e.g., one or more process optimization models may be trained to identify optimal pricing strategies for different customer segments and/or products/services while one or more other process optimization models may be trained to recommend optimized purchasing parameters.). The one or more process optimization machine learning models 114a may enable the AI agents 114 to evaluate complex enterprise processes (e.g., by evaluating adjustments to various parameters such as pricing, maintenance schedules, etc.) and generate recommended parameters for such processes (e.g., recommended adjustments to pricing, etc.). The one or more AI agents 114 may execute process optimizations using enterprise data, synthetically generated data (generated using a generative machine learning model, such as an LLM), and/or user provided data to evaluate various enterprise processes and identify optimal adjustments/configurations.

The one or more AI agents may additionally leverage memory 114b, which may enable the one or more AI agents 114 to store and retrieve historical data (e.g., including enterprise process optimization outcomes) enhancing their ability to learn from past performance and/or tools 114c, which may provide analytical and computational capabilities that support complex simulations and decision-making processes, as described further below. The one or more AI agents 114 may utilize the one or more process optimization machine learning models 114a, memory 114b, tools 114c, alone or in combination with one another to execute one or more enterprise process optimizations.

The one or more AI agents 114 may utilize the generative AI models 116 to simulate enterprise process adjustments based on outputs from the one or more process optimization models. In some examples, generative AI models 116 may include context aware LLMs that can take in indications of adjustments to enterprise processes (e.g., pricing, procurement, maintenance schedules, etc.) and output predicted outcomes (e.g., a predicted impact of various strategies, either in isolation or in combination). The system (e.g., one or more AI agents 114) may select one or more recommended adjustments based on the generative AI simulation output. In some examples, the system (e.g., one or more AI agents 114) may select a degree of an adjustment to one or more processes. In some examples, the system (e.g., one or more AI agents 114) may select a combination of recommended adjustments (e.g., pricing adjustments and purchasing adjustments to optimize COGS as a percent of revenue). Thus, enterprise process simulations executed using the one or more generative AI models 116 may simulate a plurality of interrelated processes included in an enterprise, which can include the processes optimized using the process optimization models 114a.

In some examples, generative AI models 116 may include one or more GAN models. For instance, an AI agent may be trying to model impact on EBITDA as well as client reactions based on 1) reduced procurement spend and 2) higher discounts on select products. The GAN model(s) (e.g., a cGAN model) may receive as an input both random noise and recommended process parameters (e.g., procurement and pricing parameters). A generator module of the GAN may produce synthetic datasets that reflect the unique conditions of the input and may enhance process analysis, for instance, by generating client reaction data for a range of process parameters (e.g., a range of discount levels). A discriminator module may also be conditioned on the same parameters, ensuring that it evaluates not only whether generated data is real or fake, but whether it is consistent with a given business context. Such dual conditioning may force the generator module to capture the complex, nonlinear relationships between the business interventions (e.g., process adjustments) and the resulting market responses more accurately. If historical data for these specific processes is scarce or non-existent, the GAN (e.g., a cGAN) can learn the underlying distribution of available data and generate plausible synthetic data under the new conditions. This may help to enrich the simulation inputs, making the overall analysis (e.g., of EBITDA impact and client reactions) more robust. GANs excel at learning high-dimensional data distributions and can uncover intricate patterns, complimenting process optimization models and/or other generative AI models with rich, condition-tailored data.

The one or more AI agents 114 may additionally, or alternatively, utilize the generative AI models 116, such as one or more LLMs, to process and understand natural language inputs, facilitating user interaction and intent recognition. The one or more AI agents 114 can engage with users through natural language communications, providing intuitive and accessible interactions that enhance user experience. The one or more generative AI models 116 may be trained on vast datasets to comprehend linguistic patterns and context, enabling them to interpret user queries accurately. The LLMs may also support the generation of natural language responses, images, videos, audio, and/or any combination of media modalities, allowing the AI agents 114 to communicate insights and recommendations to users and/or to one another effectively. By integrating the one or more generative AI models 116, the system 100 may enhance user experience and enable more intuitive interactions with the AI agents.

In some examples, multiple AI agents 114 may communicate using the one or more LLMs and work together to execute various process optimizations and/or enterprise process simulations. For instance, an AI agent that inspects an order backlog and prioritizes orders for high value customers may interact with an inventory optimization AI agent to ensure the right parts are sourced for the respective orders of those customers. The inventory optimization AI agent, in turn, may interact with a procurement agent to ensure that the parts are being sourced from the supplier that provides the best/optimized combination of cost and shipping speed. This collaborative functionality may allow the AI agents 114 to leverage their specialized capabilities to simulate complex enterprise processes effectively. The AI agents 114 may share data and insights, combining their expertise in areas such as pricing, inventory management, and maintenance planning to construct and/or execute holistic simulations that reflect the interconnected nature of enterprise operations. In some examples, multiple AI agents 114 may work together for other purposes, for instance, to execute enterprise process adjustments, update graphical user interfaces (e.g., user interface 108), interact with users via natural language interfaces (e.g., via user interface 108), etc. In some examples, an output of one or more of the AI agents 114 may be used to adapt the display of insights, recommendations, and performance metrics on a graphical user interface (GUI). By working together, the AI agents 114 can deliver a seamless and integrated solution that empowers enterprises to optimize processes, make informed decisions, and maintain a competitive edge in a dynamic business environment.

In some examples, system 100 is configured such that the one or more AI agents 114, one or more generative AI models 116, and/or one or more process optimization machine learning models 114a undergo continuous or periodic refinement based on tracked enterprise performance metrics, e.g., following the implementation of enterprise process adjustments. The one or more AI agents 114, one or more generative AI models 116, and/or process optimization machine learning models 114a may thus remain aligned with the evolving needs of the enterprise and consistently improve performance outcomes. For instance, system 100 may continuously or periodically monitor performance metrics to evaluate the impact of adjustments implemented based on recommendations generated by (or adjustments autonomously implemented by) the one or more AI agents 114. System 100 may collect real-time data from various enterprise systems, such as sales figures, production rates, inventory levels, and other enterprise data. The system 100 may analyze this data, identifying trends and deviations from expected performance levels. Based on the analysis of post-adjustment performance metrics, system 100 may leverage one or more of the AI agents 114 to identify areas where the adjustments have succeeded and areas that require further optimization. Alternatively, or additionally, a human may evaluate where the adjustments have succeeded and areas that require further optimization. This feedback loop may enable the one or more AI agents 114 (or human administrators) to refine the decision-making of the AI agents 114 and/or update the machine learning models 114a. The one or more process optimization machine learning models 114a may additionally be retrained/finetuned with more up-to-date enterprise data, ensuring that the models incorporate new patterns and insights, enhancing their predictive accuracy and relevance.

The one or more process optimization machine learning models 114a utilized by the one or more AI agents 114 may include regression models, clustering models, decision tree models, random forest models, optimization models, and/or other machine learning models. Each of the one or more process optimization machine learning models 114a may be trained for a particular task according to a specific training methodology to maximize its effectiveness for optimizing a respective enterprise process (e.g., customer segmentation, pricing strategies, product bundling). In some examples, one or more of the AI agents 114 may execute a plurality of the process optimization machine learning models 114a (e.g., in parallel or sequentially) to improve/optimize a respective enterprise process.

The one or more process optimization machine learning models 114a may be trained (and/or retrained, finetuned, etc.) using ML model training pipeline 112. The one or more process optimization machine learning models 114a may include a machine learning model trained to cluster customer data (e.g., via K-means or hierarchical clustering) into a plurality of customer segments using customer transaction data (e.g., a “customer clustering model”). The customer clustering model may be trained to cluster customers into distinct segments based on purchasing behavior and other relevant factors. Training the customer clustering model to cluster customer data may include evaluating the quality of customer segments output by the machine learning model and adjusting the machine learning model to optimize a number of customer segments. For instance, the customer clustering model may be adjusted to output fewer or more predicted customer segments. This customer segmentation may allow for targeted pricing strategies that cater to the unique characteristics of each group. Customer segmentation using machine learning models may also enable improved marketing strategies, personalized customer experiences, and enhanced customer retention.

The one or more process optimization machine learning models 114a may include a machine learning model trained to predict a price elasticity for one or more products (e.g., an “elasticity model”). The elasticity model may be trained to predict a price elasticity for one or more products with respect to one or more of a plurality of customer segments (e.g., which may be predicted using the machine learning model trained to cluster customers into segments) using the customer transaction data. The training data used to train the elasticity model to predict price elasticity may include customer transaction data, exogenous time-series data, and/or customer segment data predicted using customer clustering model. The elasticity model may employ regression models (e.g., linear regression, logistic regression, etc.) to estimate the price elasticity for different customer segments/products. The elasticity model may predict how changes in price may affect demand within each segment, enabling the enterprise to adjust prices strategically. Employing a machine learning model trained to cluster customer segments and a machine learning model trained to predict price elasticity for one or more of the customer segments may enable more accurate and tailored elasticity predictions, adapted to different customer segments, and thus may enable more adaptable/effective pricing models.

The one or more process optimization machine learning models 114a may include a machine learning model trained to predict an optimal pricing for a product or service (e.g., a “pricing model”). The pricing model may predict an optimal pricing for the one or more products for each of the plurality of customer segments (e.g., generated using the customer clustering model) using the predicted price elasticity (e.g., generated using the elasticity model). The training data used to train the pricing model to predict an optimal pricing for the one or more products may include customer transaction data, customer segment data predicted using the customer clustering model described above, and the price elasticity data predicted using the elasticity model described above. The pricing model may be trained to determine the optimal pricing points that maximize revenue or profit margins for different customer segments down to the individual stock-keeping-unit (SKU) level. The pricing model may be trained to consider various factors, including market trends, competitor pricing, and historical sales data. The pricing model may include a linear optimization solver or non-linear optimization model (e.g., a decision tree or random forest model).

The one or more process optimization machine learning models 114a may include a machine learning model trained to generate one or more product bundles (e.g., a “product bundling model”). The product bundling model may be trained to generate one or more product bundles using a plurality of products for each of the plurality of customer segments using the customer transaction data. The product bundling model may be trained to identify product bundles that appeal to specific customer segments (e.g., generated using the customer clustering model). The product bundling model may be trained using customer transaction data, customer segment data predicted using the customer clustering model, and/or other ERP data. The product bundling model may analyze purchasing patterns and preferences to create attractive bundle offers that enhance sales.

The machine learning model(s) 114a utilized by the one or more AI agents 114 may thus enable dynamic adaptation of pricing and product bundling strategies for various customer segments using real-time or near-real-time ERP data, market data, etc. Enterprise processes can be continuously or periodically optimized using machine learning models trained using enterprise data. The process optimization machine learning models 114a thus learn features specific to a given enterprise, its customer base, product catalog, etc., enabling more accurate and effective strategic planning and execution of enterprise process adjustments, which may be simulated to predict outcomes using generative AI models and automatically implemented using AI agents.

The one or more process optimization machine learning models 114a may include a machine learning model trained to predict one or more thresholds associated with one or more machine failure conditions (e.g., a “machine failure model”). The machine failure model may be trained using system monitoring data that may include including machine-specific operating data (e.g., sensor data, machine failure data). The machine failure model may be trained to identify thresholds associated with one or more machine failure conditions at the machine and/or site (e.g., factory, construction site, or other facility) level. The machine failure model may include a decision tree classifier, random forest model, support vector machine, neural network, or other machine learning model. The machine failure model trained may enable earlier detection of potential failures, reduce unexpected breakdowns, and improve overall maintenance planning. The machine failure model may further enable accurate determination of machine-specific thresholds indicative of a likely failure condition and may be integrated with real-time or near-real-time monitoring systems to enable rapid identification of likely failure conditions and intervention to prevent or mitigate such machine failures.

The one or more process optimization machine learning models 114a may include a machine learning model trained to predict a remaining useful life and/or a recommended maintenance schedule for one or more machines (e.g., a “maintenance scheduling model”). The maintenance scheduling model may be trained using system monitoring data that may include including machine-specific operating data (e.g., sensor data, machine failure data). The maintenance scheduling model may include, for instance, a random forest regressor, a recurrent neural network, transformer model, or other machine learning model trained to predict a remaining useful life and/or a recommended maintenance schedule. The maintenance scheduling model may enable optimized maintenance schedules, extended equipment lifespan, and cost savings. The maintenance scheduling model may be trained to learn features associated in the machine failure data and/or system monitoring data with remaining useful life and/or optimal maintenance schedules.

The one or more process optimization machine learning models 114a may include a machine learning model trained to predict a failure probability of one or more machines (e.g., a “failure probability model”). The failure probability model may be trained to predict failure probability on one or more dates using system monitoring data that may include including machine-specific operating data (e.g., sensor data, machine failure data). The failure probability model may include a logistic regression model or other probabilistic model (e.g., Bayesian networks) to predict the failure probability of machines/equipment on specific dates. The failure probability model may enable proactive maintenance interventions, minimized downtime, and improved machine reliability. The failure probability model may enable real-time or near-real-time updates to preventative maintenance schedules, prioritizing machines likely to fail in the near future based on periodically or continuously ingested ERP data, including system monitoring data that may include including machine-specific operating data (e.g., sensor data, machine failure data).

The one or more process optimization machine learning models 114a may include a machine learning model trained to predict overall equipment effectiveness (OEE) and downtime over a predefined time (e.g., an “equipment downtime model”). The equipment downtime model may be trained using system monitoring data that may include including machine-specific operating data (e.g., sensor data, machine failure data). The equipment downtime model may be configured for time-series forecasting using a weighted average of historical observations (e.g., historical sensor data, etc.). The equipment downtime model may be trained to predict OEE and/or downtime at least one week into the future, at least one month into the future, at least two months into the future, or at least three months into the future.

During an inferencing stage, any one or more of the process optimization machine learning models 114a described above may be used by the AI agent(s) 114 to optimize enterprise maintenance processes. The one or more AI agents 114 may utilize outputs (e.g., recommendations, insights, etc.) generated using the one or more process optimization machine learning models 114a to simulate the recommended adjustments and predict outcomes using one or more generative AI models 116 and/or autonomously implement adjustments to enterprise processes in the “real-world,” as described in further detail below.

Tools 114c may include, for instance, data visualization software, statistical analysis packages, and/or optimization algorithms. Tools 114c may enable the one or more AI agents 114 to perform complex calculations, generate visual representations of data, and identify optimal solutions for process improvements. Tools 114c may be designed to be flexible and adaptable, allowing the AI agents to tailor their analyses to specific enterprise needs. For instance, tools 114c may have a modular architecture, allowing components to be easily added, removed, or modified without disrupting the overall functionality of system 100 or the one or more AI agents 114. This modularity may enable the AI agents 114 to tailor their analytical processes to specific enterprise needs, selecting the most appropriate tools 114c for each simulation. Tools 114c may include configurable parameters that allow users or AI agents 114 to adjust settings based on the context of the simulation. These parameters can be set to optimize performance for different types of data, simulation goals, or computational constraints, ensuring that the tools 114c can adapt to diverse requirements. Tools 114c may enable integration with APIs, enabling AI agents 114 to access external data sources, software libraries, and computational resources. This integration may enable the tools to expand their capabilities dynamically, incorporating new functionalities and data inputs as needed for specific simulations.

The one or more AI agents 114 may include or have access to one or more cloud platforms 118. In some examples, the one or more AI agents 114 may deploy enterprise process adjustments to the cloud to incorporate the adjustments into an enterprise's real-world operations. For instance, system 100 may establishing a network communication link with a cloud platform 118 and transmit an indication of one or more process adjustments to the cloud platform 118. In some examples, the AI agents 114 may utilize the one or more cloud platforms 118 to access scalable computing resources and/or data storage. The cloud platform(s) 118 may provide the infrastructure needed to process large volumes of data and execute complex enterprise process simulations efficiently. The one or more cloud platforms 118 may also offer flexibility in resource allocation, allowing the system to scale up or down based on demand. By leveraging one or more cloud platforms 118, the system 100 can maintain high availability and reliability, supporting continuous operation and real-time data processing.

The one or more databases 102 may serve as a central or distributed repository for storing a wide array of data useful to the operation of system 100. These one or more databases 102 may be configured to receive and store data from one or more data sources 104. The one or more data sources 104 may encompass a variety of internal and external data feeds that provide the necessary inputs for system 100. For instance, the one or more data sources 104 may include enterprise resource planning (ERP) data sources, which may include financial records, supply chain information, product and/or service catalogs, human resources data, system monitoring data that may include including machine-specific operating data (e.g., sensor data, machine failure data), and/or any other enterprise data. The one or data sources 104 may additionally or alternatively include publicly available or other exogenous data sources (e.g., competitor financial data, industry data, etc.). Additionally, the one or more databases 102 may store performance metrics and/or historical data, either or both of which may have been determined using aspects of system 100, and which may provide context for analyses by the one or more AI agents 114. The one or more databases 102 may be configured to handle large volumes of data efficiently, ensuring quick retrieval and processing. The one or more databases 102 may also support data integrity and security protocols to protect sensitive enterprise information. Furthermore, the one or more databases 102 may be structured to facilitate seamless integration with other system components, such as the AI agents 114 and process optimization models 114a.

In some examples, one or more target performance thresholds 106 may be determined using system 100 and may be stored in the one or more databases 102. These target performance thresholds 106 may represent desired performance levels for various enterprise processes, serving as benchmarks for evaluating process efficiency and effectiveness. The target performance thresholds 106 may be derived from historical performance data, industry standards, and strategic business objectives. In some examples, the target performance thresholds 106 may be or include estimated future benchmarks predicted based on an estimated impact of agentic AI and other artificial intelligence systems on a respective enterprise process. As discussed above, the target performance thresholds 106 may be used by the AI agents 116 to identify underperforming processes and to guide the generation of actionable insights. The target performance thresholds 106 can be dynamically adjusted by system 100 (e.g., automatically/algorithmically or based on a user input) based on changing business conditions and priorities, ensuring that they remain relevant and aligned with enterprise goals.

The user interface 108 may enable a user to interact with the AI agents and access insights generated by the system. The user interface 108 may provide a visual representation of data insights and/or recommendations generated using the one or more AI agents 114 and/or process optimization machine learning models 114a, allowing users to interactively explore different scenarios and outcomes for various enterprise process simulations. The user interface 108 may include features such as dashboards, charts, and interactive elements that facilitate execution of enterprise process simulations and deployment of adjustments to real-world enterprise processes (e.g., pricing adjustments, preventative maintenance adjustments, inventory adjustments, procurement process adjustments, etc.). By providing a comprehensive user interface, the system empowers users to make informed decisions and optimize enterprise processes effectively.

The one or more SaaS endpoints 110 may facilitate the automated deployment of enterprise process adjustments recommended by the one or more AI agents 114. The one or more SaaS endpoints 110 may enable seamless integration with existing enterprise applications and systems, allowing for the real-time implementation of enterprise process improvements. The one or more SaaS endpoints 110 may support various deployment models, including cloud-based and on-premises solutions, providing flexibility in how adjustments are applied.

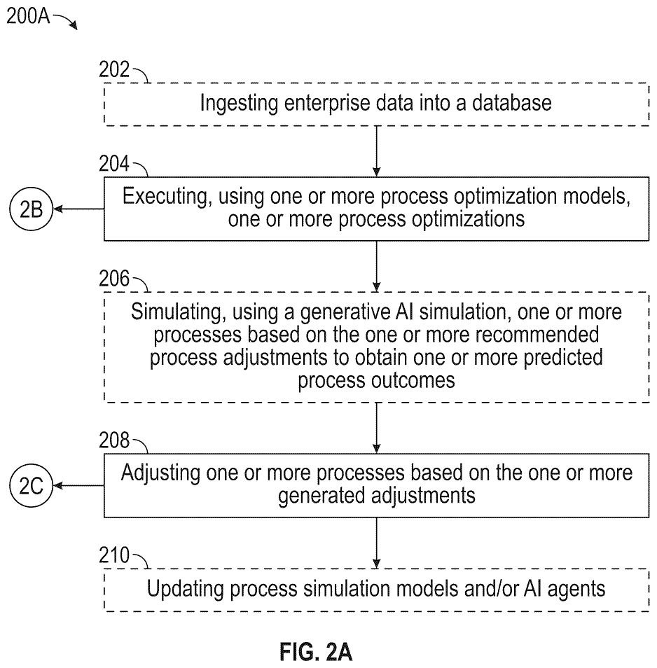

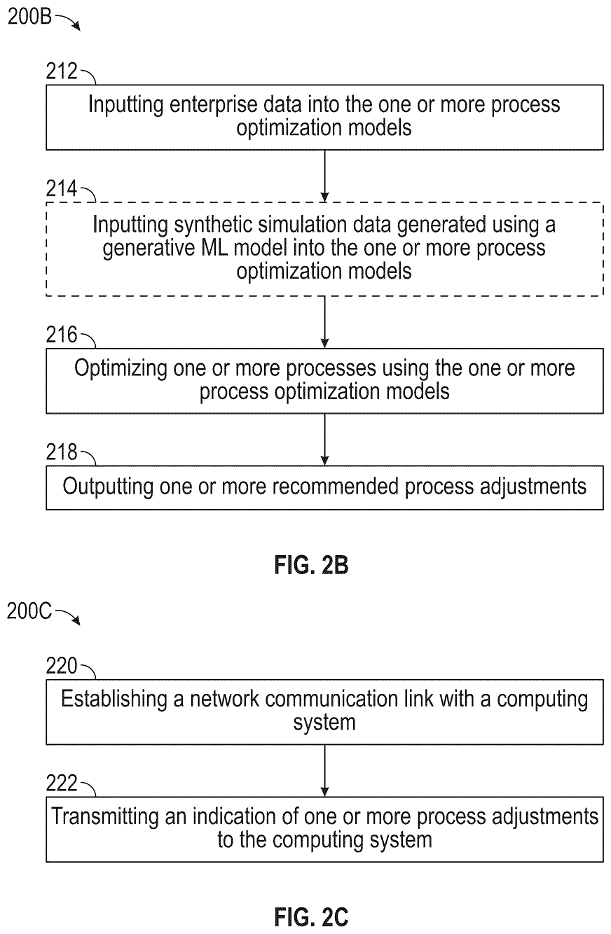

FIG. 2 illustrates an exemplary process 200 for optimizing one or more enterprise processes using AI agents. Process 200 may include using one or more of the AI agents described with reference to system 100 to simulate adjustments to enterprise processes (e.g., pricing, preventative maintenance, inventory, procurement, etc.). Adjustments to enterprise processes may be deployed autonomously using the AI agents and/or by a human-in-the-loop (e.g., based on an interaction received via a graphical user interface). The AI agents may enable dynamic optimization of enterprise processes by periodically or continuously identifying and correcting enterprise inefficiencies.

Process 200 is performed, for example, using one or more electronic devices implementing a software platform. In some examples, process 200 is performed using a client-server system, and the blocks of process 200 are divided up in any manner between the server and a client device. In other examples, the blocks of process 200 are divided up between the server and multiple client devices. Thus, while portions of process 200 may be described herein as being performed by particular devices of a client-server system, it will be appreciated that process 200 is not so limited. In other examples, process 200 is performed using only a client device or only multiple client devices. In process 200, some blocks are, optionally, combined, the order of some blocks is, optionally, changed, and some blocks are, optionally, omitted. In some examples, additional steps may be performed in combination with the process 200. Accordingly, the operations as illustrated (and described in greater detail below) are exemplary by nature and, as such, should not be viewed as limiting.

At block 202 an exemplary system including one or more electronic devices, such as one or more electronic devices included in system 100 of FIG. 1, may ingest enterprise data, including enterprise resource planning (ERP) data into a database, such as database 102 of system 100. The data ingested at block 202 may additionally include business specific key performance indicators (KPIs) and insights, third party benchmarks (e.g., enterprise performance benchmarks), and/or publicly available data (e.g., 10k information, including from industry peers of an organization implementing process 200). Ingesting the data at block 202 may include cleaning the data, converting the data into a common format, enforcing a data schema, aggregating the data, or otherwise processing the ingested data. The ingested data may be organized in the database according to varying degrees of processing, aggregation, or use case. For instance, cleaned and formatted training data used to train one or more process optimization machine learning models disclosed herein may be stored in a portion of the database separate from raw ERP data or ERP data otherwise not yet formatted for training.

The ERP data and/or other data may be periodically or continuously ingested and analyzed by the exemplary system. In some examples, the exemplary system may ingest the data at block 202 and compare aspects of the ingested data to performance thresholds to identify underperforming (or overperforming) enterprise processes (e.g., pricing for goods and/or services, preventative maintenance schedules, inventory processes, procurement processes, etc.). The performance threshold(s) and/or criteria for a given enterprise process may be determined based on industry-specific and/or company-specific factors. In some examples, the performance threshold(s) for a given enterprise process may be predicted based upon a predicted impact of AI agent use with respect to the enterprise process. For instance, a performance threshold for a given enterprise process may be relatively higher in areas expected to experience significant efficiency increases with use of AI agents and relatively lower in areas expected to experience less efficiency increases with use of AI agents. The system may indicate (e.g., via a graphical user interface) how various enterprise processes are performing relative to relevant performance thresholds.

At block 204, the exemplary system may execute, using one or more AI agents and/or one or more process optimization models (e.g., AI agents 114 and process optimization models 114a), one or more process optimizations. As discussed above, the exemplary system may periodically or continuously process the data ingested at block 202 to determine enterprise performance metrics relative to one or more threshold performance metrics. The one or more enterprise process optimizations may be executed when one or more enterprise processes are performing below a given performance threshold and/or fail to satisfy a performance criteria (e.g., evaluated using a classification model). In some examples, one or more AI agents may identify appropriate process optimization models and/or other AI agents suitable for optimizing the one or more underperforming processes (e.g., models and/or agents specifically configured to optimize pricing strategies, maintenance strategies, etc.), The one or more AI agents execute process optimizations using one or more process optimization machine learning models to identify recommended adjustments/parameters for those processes. The one or more process optimization machine learning models may output recommendations and/or insights based. The output recommendations may thus include, for instance, enterprise process recommendations, such as pricing strategies, maintenance strategies, procurement strategies, etc.

In some examples, the one or more enterprise process optimizations may be executed automatically using the one or more AI agents. For example, one or more AI agents may continuously or periodically monitor enterprise process performance relative to one or more performance thresholds. The one or more enterprise process optimizations may be constructed and/or executed by the one or more AI Agents based on one or more identified areas of performance degradation. For instance, if the one or more AI agents determines that one or more enterprise processes are performing below a performance threshold and/or fails to satisfy a performance criteria, the one or more AI agents may automatically select one or more process optimization models and/or one or more AI agents execute an enterprise process optimization to identify one or more adjustments that may improve performance relative to the threshold. This proactive, automated, approach may enable enterprises to maintain optimal operational efficiency and rapidly address any emerging issues.

Additionally, or alternatively, the one or more enterprise process optimizations may be or executed in response to a user input (e.g., a natural language prompt and/or selection received via a graphical user interface). Users can interact with a graphical user interface (GUI) that displays the performance of various enterprise processes relative to relevant threshold performance metrics. Through the GUI, users can easily identify areas where performance is lacking or where improvements could be made. Upon identifying such areas, users can prompt one or more AI agents to execute optimizations (and/or simulations) by providing input through the GUI, voice commands, and/or natural language inputs. This user-driven approach may empower decision-makers to leverage AI-driven insights to address specific performance concerns and optimize enterprise processes effectively. In some examples, one or more of the AI agents may determine a user intent based on a prompt (e.g., natural language prompt) and may execute one or more enterprise process optimizations (and/or process simulations, as described above and in more detail below) based on the determined user intent. For instance, one or more of the AI agents may be equipped with advanced natural language processing (NLP) capabilities that enable them to accurately interpret user intent from prompts. When a user provides input, whether through a graphical user interface, voice command, or natural language text, the one or more AI agents may analyze the content of the prompt to determine the appropriate optimizations to execute.

In some examples, the one or more AI agents may utilize generative AI models (e.g., generative AI models 116), such as transformer-based models like LLAMA or GPT, to parse and understand the user's input. These models are trained to recognize linguistic patterns and extract relevant information from the text, allowing the AI agents to comprehend the user's request in context. The one or more AI agents may employ intent recognition algorithms to identify the specific intent behind the user's prompt. This may involve categorizing the input into predefined intent categories, such as “simulate pricing adjustment,” “analyze maintenance schedule,” “optimize inventory,” or “review procurement process.” The one or more AI agents may use machine learning classifiers, such as support vector machines (SVMs) or neural networks, to accurately classify the intent based on the input prompt. The one or more AI agents may also perform contextual analysis to consider additional information provided by the user or derived from previous interactions. This may include considering the current state of enterprise processes, historical ERP data, and/or any specific parameters or constraints mentioned in the prompt. As discussed above, by incorporating this context, the one or more AI agents may tailor the optimizations (and/or simulation) to address the user's specific needs and objectives. Based on the determined intent and contextual analysis, the one or more AI agents may execute the appropriate optimizations to execute. For instance, in some examples, an orchestrator AI agent may be configured to communicate with users and/or monitor performance metrics to determine when an enterprise process optimization should be executed to optimize a given performance metric. The orchestrator AI agent may communicate with other AI agents that include or have access to relevant process optimization machine learning models useful to optimize a given enterprise process. The orchestrator AI agent may identify the appropriate AI agent(s) to execute a optimization (and/or simulation) and instruct that AI agent to proceed with executing the optimization (and/or simulation).

In some examples, executing the one or more enterprise process optimizations includes determining a recommended adjustment to a price of a product or service. This may involve using one or more AI agents and process optimization machine learning models to analyze how changes in pricing can impact demand, revenue, and/or profitability. The process optimization machine learning models employed, such as regression models, decision trees, or other machine learning models (for instance, classification models, random forest, recurrent neural networks (RNNs), support vector machines (SVMs), transformer models, reinforcement learning, or other machine learning models), may predict the price elasticity and optimal pricing strategies, e.g., for different customer segments and/or products. The recommendations and/or insights generated from these optimizations may enable enterprises to make informed decisions regarding pricing strategies, ultimately enhancing revenue optimization and market competitiveness.

In some examples, executing the one or more enterprise process optimizations includes determining recommended adjustments to a maintenance schedule for a machine or factory. For instance, one or more AI agents may utilize one or more preventative maintenance machine learning models (for instance, classification models, regression models, decision trees, random forest, recurrent neural networks (RNNs), support vector machines (SVMs), transformer models, reinforcement learning, or other machine learning models) to forecast equipment failures and recommend optimal maintenance schedules. Thus, enterprises can gain insights into potential downtime reductions and maintenance cost savings, thereby improving operational efficiency and equipment reliability.

In some examples, executing the one or more enterprise process optimizations includes determining recommended adjustments to an inventory process. For instance, one or more AI agents may use one or more process optimization machine learning models (for instance, classification models, regression models, decision trees, random forest, recurrent neural networks (RNNs), support vector machines (SVMs), transformer models, reinforcement learning, or other machine learning models) to predict demand fluctuations and recommend certain inventory levels. The recommendations generated from these optimizations may help enterprises minimize holding costs, reduce stockouts, and improve inventory turnover rates. Such models may enable more efficient inventory management and may enable alignment between inventory strategies and market demand.

In some examples, executing the one or more enterprise process optimizations includes determining recommended adjustments to a procurement process. For instance, one or more AI agents may employ one or more process optimization machine learning models (for instance, classification models, regression models, decision trees, random forest, recurrent neural networks (RNNs), support vector machines (SVMs), transformer models, reinforcement learning, or other machine learning models) to evaluate supplier performance and/or recommend optimizations for purchase order management. Enterprises can thus gain insights into cost-saving opportunities, supplier reliability, and procurement efficiency.

The one or more process optimization machine learning models used to execute the one or more enterprise process optimizations may be included in, or accessible by, the one or more AI agents. In some examples, each of the one or more process optimization machine learning models is trained for a particular task (e.g., clustering customer segments, predicting price elasticity, etc.). In some examples, a plurality of process optimization machine learning models each trained to perform different tasks may be utilized to execute an enterprise process optimization. For instance, an intelligent pricing AI agent may utilize a plurality of process optimization machine learning models trained to generate enterprise pricing recommendations using ERP data, including, for instance, by segmenting customers, determining pricing elasticity, optimizing pricing, and identifying product bundling strategies.

A first machine learning model that may be used by the intelligent pricing AI agent may be trained to cluster customer data (e.g., via K-means or hierarchical clustering) into a plurality of customer segments using customer transaction data. The first machine learning model may be trained to cluster customers into distinct segments based on purchasing behavior and other relevant factors. Training the first machine learning model to cluster customer data may include evaluating the quality of customer segments output by the machine learning model and adjusting the machine learning model to optimize a number of customer segments. For instance, the machine learning model may be adjusted to output fewer or more customer segments. This customer segmentation may allow for targeted pricing strategies that cater to the unique characteristics of each group. Customer segmentation using machine learning models may also enable improved marketing strategies, personalized customer experiences, and enhanced customer retention.

A second machine learning model that may be used by the intelligent pricing AI agent may be trained to predict a price elasticity for one or more products with respect to one or more of the plurality of customer segments using the customer transaction data. The training data used to train the second machine learning model may include customer transaction data, exogenous time-series data, and/or customer segment data predicted using the first machine learning model trained to cluster customers into segments described above. The second machine learning model may employ regression models (e.g., linear regression, logistic regression, etc.) to estimate the price elasticity for different customer segments/products. The second machine learning model may predict how changes in price may affect demand within each segment, enabling the enterprise to adjust prices strategically. Employing a machine learning model trained to cluster customer segments and a machine learning model trained to predict price elasticity for one or more of the customer segments may enable more accurate and tailored elasticity predictions, adapted to different customer segments, and thus may enable more adaptable/effective pricing models.

A third machine learning model that may be used by the intelligent pricing AI agent may be trained to predict an optimal pricing for the one or more products for each of the plurality of customer segments using the predicted price elasticity. The training data used to train the third machine learning model to predict an optimal pricing for the one or more products may include customer transaction data, customer segment data predicted using the first machine learning model described above, and the price elasticity data predicted using the second machine learning model described above. The third machine learning model may be trained to determine the optimal pricing points that maximize revenue or profit margins for different customer segments down to the individual stock-keeping-unit (SKU) level. The third machine learning model may be trained to consider various factors, including market trends, competitor pricing, and historical sales data. The third machine learning model may include a linear optimization solver or non-linear optimization model (e.g., a decision tree or random forest model).

A fourth machine learning model that may be used by the intelligent pricing AI agent may be trained to generate one or more product bundles using a plurality of products for each of the plurality of customer segments using the customer transaction data. The fourth machine learning model may be trained to identify product bundles that appeal to specific customer segments. The fourth machine learning model may be trained using customer transaction data, customer segment data predicted using the first machine learning model described above, and/or other ERP data. The fourth machine learning model may analyze purchasing patterns and preferences to create attractive bundle offers that enhance sales. The machine learning model(s) utilized by the intelligent pricing AI agent may enable dynamic adaptation of pricing and product bundling strategies for various customer segments using real-time or near-real-time ERP data, market data, etc. Enterprise processes can be continuously or periodically optimized using process optimization machine learning models trained using enterprise data. The process optimization machine learning models can thus learn features specific to a given enterprise, its customer base, product catalog, etc., enabling more accurate and effective strategic planning and execution of enterprise process adjustments, which may be devised and autonomously implemented using LLM-powered AI agents.

During an inferencing stage, any one or more of the process optimization machine learning models described above with reference to the intelligent pricing AI agent(s) may be used by the AI agent(s) to recommend adjustments to various enterprise processes (e.g., pricing strategies, etc.) The AI agent(s) may utilize these recommended adjustments to simulate enterprise processes using generative AI models and may autonomously deploy some recommended adjustments in the “real-world,” as described in further detail below.

As another example, a preventative maintenance AI agent may utilize one or more process optimization machine learning models trained to generate preventative maintenance insights using ERP data. The preventative maintenance AI agent may use one or more process optimization machine learning models, for instance, to forecast equipment failures and schedule maintenance activities proactively, thereby reducing downtime and maintenance costs. A first machine learning model that may be used by the preventative maintenance AI agent may be trained to predict one or more thresholds associated with one or more machine failure conditions using system monitoring data that may include including machine-specific operating data (e.g., sensor data, machine failure data). The first machine learning model that may be used by the preventative maintenance AI agent may be trained to identify thresholds associated with one or more machine failure conditions at the machine and/or site (e.g., factory, construction site, or other facility) level. The first machine learning model may include a decision tree classifier, random forest model, support vector machine, neural network, or other machine learning model. The first machine learning model trained to predict thresholds associated with failure conditions may enable earlier detection of potential failures, reduce unexpected breakdowns, and improve overall maintenance planning. The machine learning model trained to predict thresholds associated with failure conditions may further enable accurate determination of machine-specific thresholds indicative of a likely failure condition and may be integrated with real-time or near-real-time monitoring systems to enable rapid identification of likely failure conditions and intervention to prevent or mitigate such machine failures.

A second machine learning model that may be used by the preventative maintenance AI agent may be trained to predict a remaining useful life and/or a recommended maintenance schedule for one or more machines using system monitoring data that may include including machine-specific operating data (e.g., sensor data, machine failure data). The second machine learning model may include, for instance, a random forest regressor, a recurrent neural network, transformer model, or other machine learning model trained to predict a remaining useful life and/or a recommended maintenance schedule. The machine learning model trained to predict a remaining useful life and/or a recommended maintenance schedule using historical machine failure data may enable optimized maintenance schedules, extended equipment lifespan, and cost savings. The machine learning model may be trained to learn features associated in the machine failure data and/or system monitoring data with remaining useful life and/or optimal maintenance schedules.

A third machine learning model that may be used by the preventative maintenance AI agent may be trained to predict a failure probability of one or more machines on one or more dates using system monitoring data that may include including machine-specific operating data (e.g., sensor data, machine failure data). The third machine learning model may include a logistic regression model or other probabilistic model (e.g., Bayesian networks) to predict the failure probability of machines/equipment on specific dates. The third machine learning model trained to predict a failure probability of one or more machines may enable proactive maintenance interventions, minimized downtime, and improved machine reliability. The machine learning model trained to predict the failure probability of one or more machines may enable real-time or near-real-time updates to preventative maintenance schedules, prioritizing machines likely to fail in the near future based on periodically or continuously ingested ERP data, including system monitoring data that may include including machine-specific operating data (e.g., sensor data, machine failure data).

A fourth machine learning model that may be used by the preventative maintenance AI agent may be trained to predict overall equipment effectiveness (OEE) and downtime over a predefined time. The fourth machine learning model may be trained using system monitoring data that may include including machine-specific operating data (e.g., sensor data, machine failure data). The fourth machine learning model may be configured for time-series forecasting using a weighted average of historical observations (e.g., historical sensor data, etc.). The fourth machine learning model that may be used by the preventative maintenance AI agent may be trained to predict OEE and/or downtime at least one week into the future, at least one month into the future, at least two months into the future, or at least three months into the future.

During an inferencing stage, any one or more of the process optimization machine learning models described above with reference to the preventative maintenance AI agent(s) may be used by the AI agent(s) to determine recommended adjustments to various enterprise processes. Like with the intelligent pricing AI agent(s), the preventative maintenance AI agent(s) may utilize these recommendations simulate adjustments using one or more generative AI models to predict outcomes for various process adjustments and identify an optimal set of one or more adjustments (optionally including a degree to which any adjustment is implemented) and/or may autonomously implement adjustments to enterprise processes in the “real-world” for the enterprise, as described in further detail below.

In some examples, one or more process optimization machine learning models used to recommend enterprise process adjustments may include at least one machine learning model trained to generate inventory insights and/or recommendations using ingested ERP data. Such model(s) may be trained to forecast demand, determine optimized inventory levels, etc. For demand forecasting, one or more AI agents may utilize time-series models such as ARIMA (Auto Regressive Integrated Moving Average) or LSTM (Long Short-Term Memory) networks to predict future demand patterns based on historical sales data and market trends. This may enable an enterprise to maintain optimal inventory levels, reducing both stockouts and excess inventory. Additionally, or alternatively, one or more AI agents may employ optimization models, such as linear programming models or genetic algorithms, to determine the optimal inventory levels that minimize holding costs while ensuring product availability. This may involve analyzing various factors, including lead times, supplier reliability, and demand variability. Furthermore, the AI agent may use process optimization machine learning models like decision trees or random forests to determine reorder points for different products, enabling timely replenishment and efficient inventory turnover.

In some examples, one or more process optimization machine learning models used to execute enterprise process optimizations may include at least one machine learning model trained to generate procurement insights based on ERP data. One or more AI agents may analyze procurement processes by utilizing process optimization machine learning models to generate recommendations with respect to supplier selection, purchase order management, and/or costs. A classification model, such as a support vector machine (SVM) or a neural network, may be trained to evaluate and identify preferred suppliers based on criteria such as price, quality, and delivery performance, which may enable the enterprise to build a reliable supplier network and improve procurement efficiency. Further, the AI agent may employ predictive models, such as regression models or Bayesian networks, to forecast procurement costs and identify cost-saving opportunities. These models analyze historical procurement data and market conditions to provide insights into optimal purchasing strategies. The one or more AI agents may utilize reinforcement learning algorithms to enable optimization of order quantities and timing to align with demand forecasts and inventory levels.

In some examples, the exemplary system may construct one or more process optimizations using one or more AI agents prior to executing the optimizations. The one or more AI agents may select one or more process optimization machine learning models tailored to a given enterprise process (e.g., clustering models for identifying customer segments based on purchasing patterns, regression models for predicting price elasticity, etc.). The AI agents may input enterprise and/or external data (e.g., market data) into the one or more process optimization machine learning models, and the one or more process optimization machine learning models may enable the AI agents to identify potential modifications to complex enterprise processes, as discussed above. In some examples, the one or more AI agents may leverage a library of optimization models that correspond to different enterprise processes and scenarios. For instance, rather than constructing a new enterprise process optimization each time one is needed, the system may query a database of already existing optimization (e.g. sets of process optimization machine learning models, prompting, etc.) and identify an optimization suitable for a new process or scenario. In such examples, once a suitable optimization is identified, the AI agents may initiate the execution process, generating insights and/or recommendations that align with the user's intent and/or enterprise goals.

The one or more AI agents may additionally leverage generative AI models to construct and execute complex enterprise process simulations, which may utilize the recommendations generated using one or more of the process optimization machine learning models, enabling the AI agents to explore a wide range of scenarios and generate select an optimal set of one or more enterprise process adjustments.

At block 206, the exemplary system may simulate, using a generative AI simulation, one or more processes based on the one or more recommended process adjustments to obtain one or more predicted process outcomes. In some examples, the one or more adjustments are simulated using a generative machine learning model, such as an LLM or GAN. The one or more simulated adjustments may include an adjustment to a price for a product or service, an adjustment to a preventative maintenance schedule, an adjustment to an inventory, and/or an adjustment to a procurement process. For instance, the one or more process optimization models may recommend changes to the pricing of products or services based on enterprise process insights process optimizations with reference to customer segments, products, services, elasticity, and/or bundling strategies. The one or more process optimization machine learning models may recommend changes to preventative maintenance to minimize downtime and extend equipment life, thereby enhancing operational efficiency. The one or more process optimization machine learning models may recommend adjustments to inventory levels, reorder points, etc., based on inventory process optimizations. The one or more process optimization machine learning models may recommend adjustments to procurement processes, such as supplier selection or order quantities, based on procurement process optimizations.

The recommendations may be provided, optionally along with additional data, including any of the data ingested at block 202, to a generative AI model to simulate process outcomes based on the recommended adjustments. The generative AI model(s), such as LLMs, GANs, and/or other generative AI models, can produce high-fidelity, complex enterprise process simulations that model a wide range of processes, from pricing to procurement and preventative maintenance, etc., and output predicted outcomes and/or indications of optimal sets of one or more process adjustments (optionally including a degree to which any adjustment is implemented). To construct and execute enterprise process simulations, the AI agents may identify relevant enterprise data for a given simulation and input the relevant enterprise data into one or more generative AI models alongside recommendations generated using the process optimization models. The input data to the generative AI model(s) may include historical performance metrics, market trends, customer behavior, operational parameters, and/or any other enterprise data or external data. The one or more generative AI models may process this data to identify latent structures and correlations, which may then be used to generate synthetic data that represents potential outcomes, such as customer reaction data, predicted profits, simulated equipment data, etc., allowing the system to model a range of outcomes for any number of potential process adjustments. In some examples, the AI agents may additionally or alternatively utilize user-provided data (e.g., user-generated pricing schemes, maintenance schedules, etc.) to conduct the enterprise process simulations. The system may select an optimal strategy including one or more adjustments based on the output of the generative AI enterprise process simulation to recommend to a user and/or autonomously deploy.

At block 208, the exemplary system may adjust one or more processes based on the output of the enterprise process simulation. In some examples, the one or more AI agents may deliver recommendations to users through a graphical user interface (GUI). The GUI may present the recommendations in a clear and actionable format, allowing users to review and approve the suggested changes. This interactive approach enables decision-makers to consider the AI-driven insights alongside their strategic objectives and operational constraints. Alternatively, the AI agents may autonomously implement the generated adjustments without user intervention. This automated implementation may be particularly beneficial in scenarios where rapid response is critical, such as equipment failure mitigation or real-time inventory management. The system may ensure that any automatic changes are aligned with predefined business rules and thresholds to maintain control over enterprise operations. After implementing the adjustments, the system and/or AI agents may continue to monitor the impact of these changes on enterprise performance. This ongoing evaluation may allow the system to refine its models and recommendations over time, enabling continuous improvement. By learning from the outcomes of implemented changes, the AI agents may enhance their predictive accuracy and decision-making capabilities.

At block 210, the one or more AI agents and/or one or more process optimization machine learning models are optionally updated. The one or more AI agents and/or one or more process optimization machine learning models may undergo continuous or periodic refinement based on tracked enterprise performance metrics, e.g., following the implementation of enterprise process adjustments. The one or more AI agents and/or process optimization machine learning models may thus remain aligned with the evolving needs of the enterprise and consistently improve performance outcomes. For instance, an exemplary system (e.g., system 100) may continuously or periodically monitor performance metrics to evaluate the impact of adjustments implemented based on recommendations generated using the one or more process optimization machine learning models. The system may collect real-time data from various enterprise systems, such as sales figures, production rates, inventory levels, and other enterprise data. The system may analyze this data, identifying trends and deviations from expected performance levels. Based on the analysis of post-adjustment performance metrics, system may leverage one or more of the AI agents 114 to identify areas where the adjustments have succeeded and areas that require further optimization. Alternatively, or additionally, a human may evaluate where the adjustments have succeeded and areas that require further optimization. This feedback loop may enable the one or more AI agents (or human administrators) to refine the decision-making of the AI agents and/or update the machine learning models. The one or more process optimization machine learning models may additionally be retrained/finetuned with more up-to-date enterprise data, ensuring that the models incorporate new patterns and insights, enhancing their predictive accuracy.

FIG. 2B illustrates an exemplary process 200B showing additional detail with respect to executing the one or more process optimizations using one or more process optimization machine learning models of the one or more AI agents at block 204. Process 200B may be performed using one or more aspects of system 100. At block 212, an exemplary system (e.g., one or more electronic devices) performing process 200B may input enterprise data into one or more process optimization models (e.g., any of the process optimization machine learning models described with reference to FIG. 1 or FIG. 2A). The enterprise data may include any of the data discussed with reference to FIG. 1 or FIG. 2A. At block 214, the exemplary system optionally inputs synthetic simulation data generated using a generative AI model into the one or more process optimization models, for instance, as described above with reference to process 200A. At block 216, the exemplary system optimizes the one or more processes using the one or more process optimization models. At block 218, the exemplary system outputs one or more recommendations (e.g., optimal prices, optimal maintenance dates, etc.).

FIG. 2C illustrates an exemplary process 200C showing additional detail with respect to block 208 of process 200A. Process 200C may be performed using one or more aspects of system 100. At block 220, an exemplary system (e.g., one or more electronic devices) may establish a network communication link with a computing system (e.g., a cloud computing platform, on-premises computing platform, or other computing system or device). The network communication link may use any wired or wireless communications protocol. At block 222, the exemplary system may transmit an indication of one or more process adjustments to the computing system. The indication of one or more process adjustments to the computing system may include pricing adjustments, preventative maintenance scheduling adjustments, inventory adjustments, procurement process adjustments, and/or adjustments to any other enterprise process. Transmitting the indication of one or more process adjustments to the computing system may cause the receiving computing system to automatically deploy the adjustments to real-world enterprise processes.

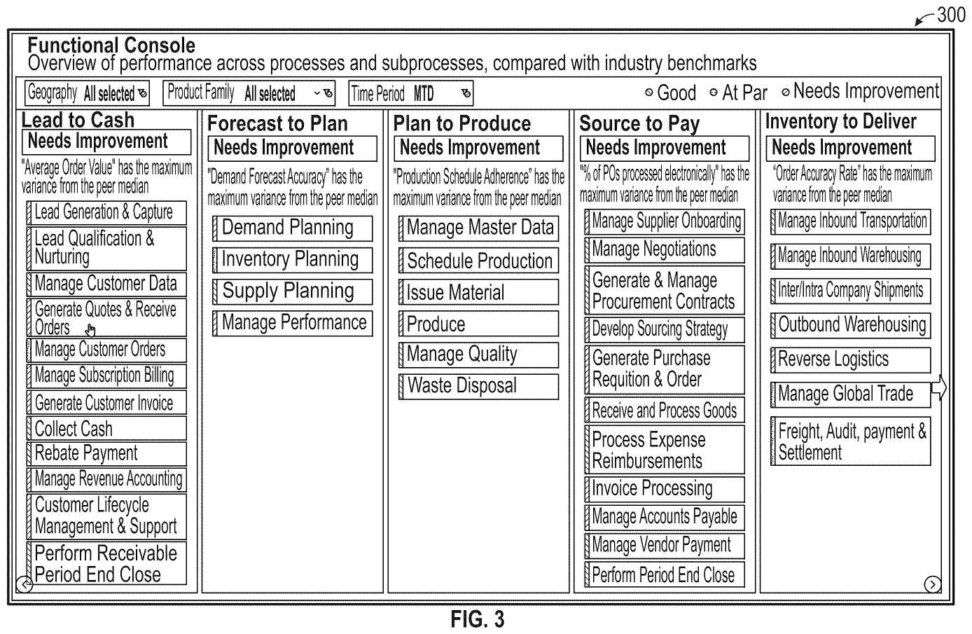

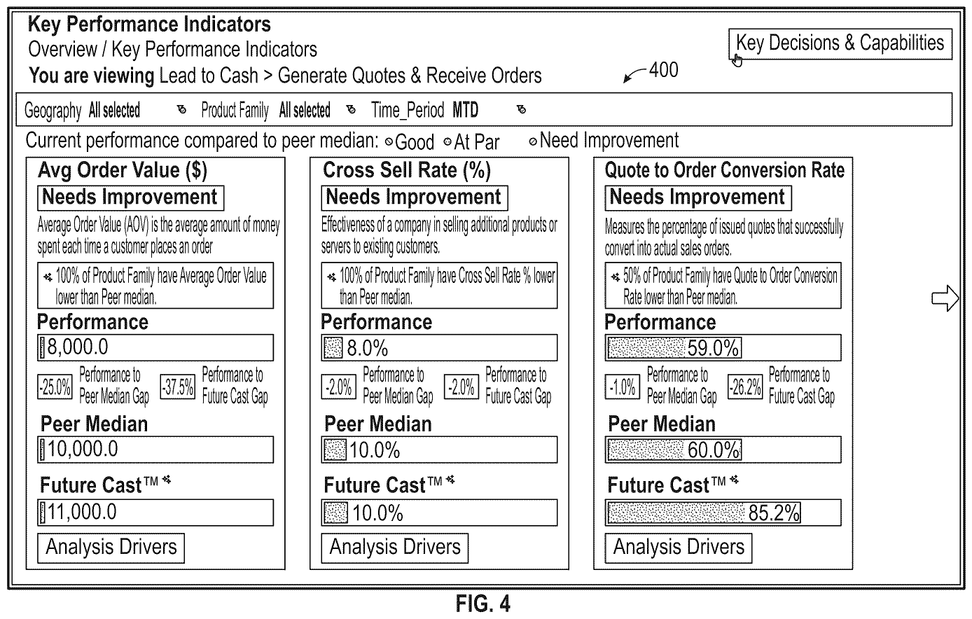

As described above, system 100 may include (and aspects of process 200 may utilize) a graphical user interface (GUI) that enables interaction with AI agents, process optimization machine learning models, and/or generative AI models to determine actionable insights and deploy adjustments to various enterprise processes. FIG. 3 illustrates exemplary aspects of a first GUI 300 screen that may provide real-time insights into enterprise process performance, highlighting overperforming (Green), at par (Yellow), and underperforming (Red) processes. A user may interact with GUI 300 and select a process (e.g., an underperforming process such as “Generate Quotes and Receive Orders”) for further analysis. Upon selection of a process, such as Generate Quotes and Receive Orders, the GUI may display a second GUI screen 400, exemplary aspects of which are shown in FIG. 4. GUI screen 400 may display performance metrics of the Generate Quotes and Receive Orders process, which may be a sub-process of enterprise pricing. GUI screen 400 may display performance metrics for average order value (a function of revenue and the #of orders, which may be determined using the ERP data ingested by system 100 and/or according to process 200), cross sell rate, and/or quote to order conversion rate relative to peer median performance thresholds and/or predicted performance thresholds based on industry data and estimates of AI agent driven efficiencies

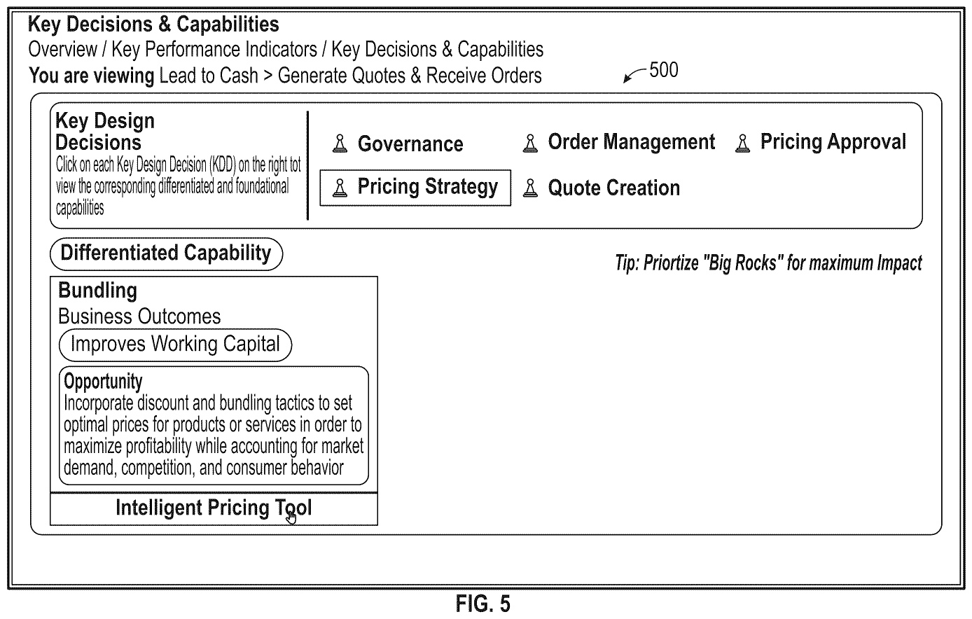

A user may access a third GUI screen 500, exemplary aspects of which are shown in FIG. 5, via GUI screen 400. GUI screen 500 may be a “Key Decisions & Capabilities” screen which may enable access to one or more of the AI agents accessible via the systems disclosed herein (e.g., system 100). For example, a pricing strategy AI agent for product bundling may be accessible. The pricing strategy AI agent for product bundling may utilize any one or more of the process optimization machine learning models described with reference to the intelligent pricing AI agent of process 200 to generate enterprise process insights and/or recommend agentic AI solutions/enterprise process adjustments that may remediate identified performance deficiencies.

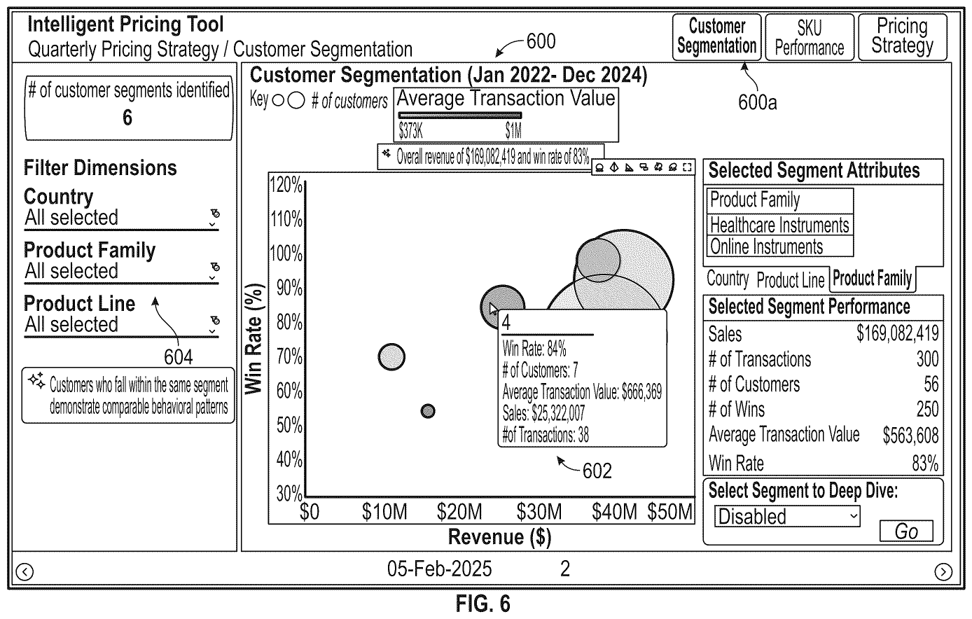

Tools for interacting with the one or more of the AI agents accessible via GUI screen 500 may, in turn, be accessible on a fourth GUI screen 600, exemplary aspects of which are shown in FIG. 6. For example, an intelligent pricing AI agent (e.g., such as the one described with reference to process 200) may provide guidance on optimal pricing and discounts strategy, e.g., to improve the Average Order Value metric described with reference to GUI screen 400. GUI screen 600 may enable users to toggle between different displays, including display 600a, display 600b, and/or display 600c. Display 600a may display one or more customer segments generated using one or more AI agents (e.g., the intelligent pricing AI agent of process 200). Display 600b may display enterprise process insights generated using one or more AI agents (e.g., the intelligent pricing AI agent of process 200). Display 600c may display recommended pricing strategies (e.g., selling prices, product bundles, etc.) generated using one or more AI agents (e.g., the intelligent pricing AI agent of process 200). It should be understood that while displays 600a-600c are described with reference to an intelligent pricing AI agent, analogous screens may be generated using the preventative maintenance AI agent described with reference to process 200. Each of displays 600a-600c may be interactive graphical user interfaces. In some examples, one or more aspects of the graphical user interface displays are manually coded. In some examples, one or more aspects of the graphical user interface displays are dynamically rendered based on an output of the one or more AI agents.

Display 600a may enable a user to execute one or more enterprise process optimizations and/or simulations using one or more AI agents (e.g., the intelligent pricing AI agent of process 200), for instance, to cluster customers into customer segments (e.g., based on historical buying patterns). The one or more AI agents may utilize one or more process optimization machine learning models (e.g., clustering models) to generate customer segments, for instance, based on purchasing behaviors. Display 600a may indicate a number of customer segments that were created (e.g., for a respective product family) using one or more process optimization machine learning models. Display 600a may indicate various attributes associated with each of the customer segments, including overall sales, number of transactions, number of customers, number of “wins” (e.g., sales), average transaction value, and/or win rate (e.g., conversion rate). Users may interact with display 600a to drill down on additional attributes associated with each segment, for instance, by hovering over customer segment icons depicted on a graphical representation 602 of the customer segments (e.g., bubble chart). Display 600a may enable users to generate (e.g., using the one or more machine learning models associated with the intelligent pricing AI agent) customer segments by country, product family, product line, etc., for instance, using the interactive icons 604 shown on display 600a.

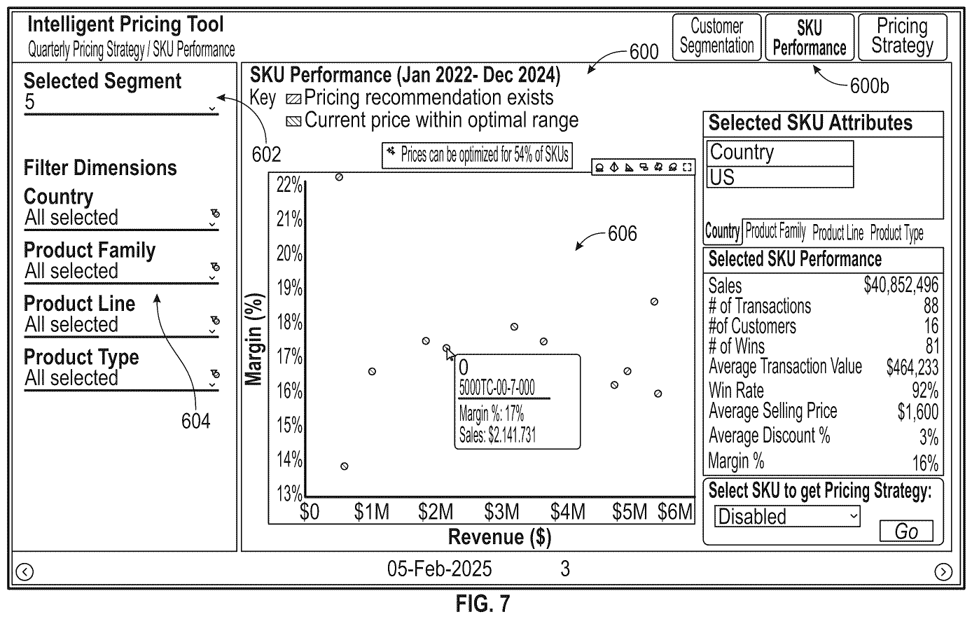

FIG. 7 illustrates aspects of display 600b. Display 600b may include indications of pricing performance generated using one or more AI agents (e.g., the intelligent pricing AI agent described with reference to process 200). Display 600b may enable users to select a customer segment for analysis using a selectable icon 602. One or more AI agents (e.g., the intelligent pricing AI agent of process 200) may execute one or more enterprise process optimizations and/or simulations using one or more process optimization machine learning models and/or generative AI models. For instance, one or more AI agents may execute one or more optimizations and/or simulations for a selected customer segment (e.g., selected using icon 602). Display 600b may include one or more additional selectable icons 602 that enable a user to filter/tailor simulations by country, product family, product line, product type, etc. Display 600b may include a graphical representation 606 depicting results of the one or more enterprise process optimizations and/or simulations executed by the one or more AI agents. For example, the intelligent pricing AI agent may utilize one or more process optimization machine learning models to predict optimal pricing ranges for one or more customer segments (e.g., a segment selected using icon 602). The intelligent pricing AI agent may compare current prices to the optimal range and generate an indication of whether a current price falls within the optimal pricing range determined using the one or more process optimization machine learning models. The indication of whether the current price falls within the optimal pricing range may be displayed in the graphical representation 606. The indication of whether the current price falls within the optimal pricing range may be displayed for one or more products or services (e.g., stock keeping unit (SKU)) associated with a respective customer segment. If the current price does not fall within the optimal pricing range for one or more of the products or services, graphical representation 606 may include an indication that a pricing recommendation (generated by the one or more AI agents) exists. The pricing recommendation may be accessible via GUI screen 600.

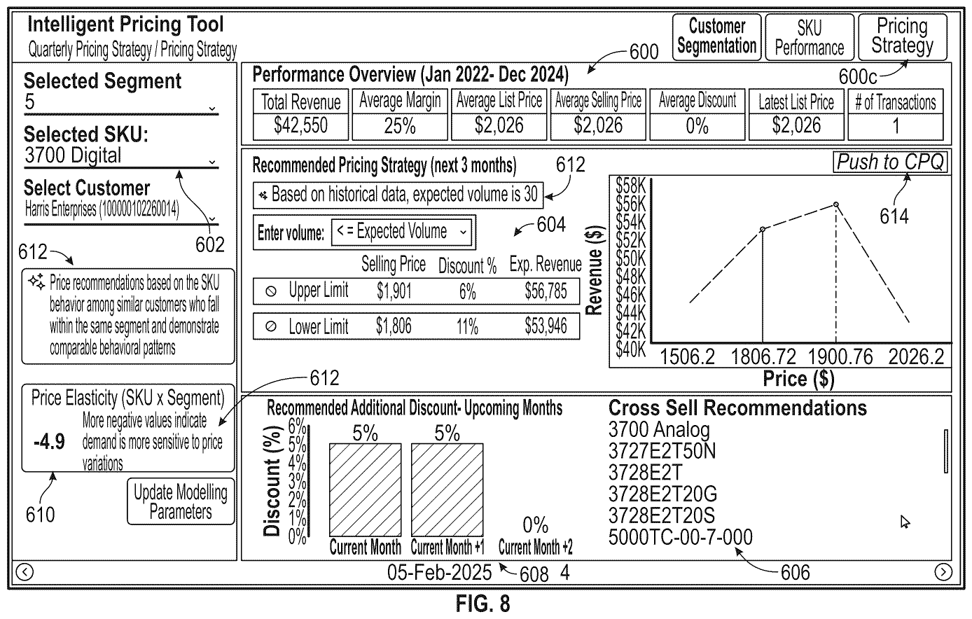

FIG. 8 illustrates aspects of display 600c. Display 600c may indicate recommendations generated by one or more AI agents (e.g., the intelligent pricing AI agent) for one or more selected customer segments and/or stock keeping units (SKUs). For instance, display 600c may enable a user to select a customer segment, SKU, an/or a selected customer using one or more interactive icons 602. One or more AI agents may execute one or more enterprise process optimizations and/or simulations based on a user input (e.g., using the selected customer segment, SKU, and/or a selected customer receive via the one or more icons 602). Display 600c may include a first interactive display section 604. The first interactive display section 604 may include recommended pricing strategies, for instance, for the selected segment, SKU, and/or customer, which may be generated using the one or more process optimization machine learning models used by the intelligent pricing AI agent described with reference to process 200. Display 600c may include a second interactive display section 606 that includes one or more cross-sell recommendations (e.g., bundling recommendations), which may be generated using the one or more process optimization machine learning models used by the intelligent pricing AI agent described with reference to process 200. Display 600c may include a third interactive display section 608 that includes recommended discounting strategies, which may be generated using one or more process optimization machine learning models used by the intelligent pricing AI agent described with reference to process 200. Display 600c may also include an indication of a predicted price elasticity 610 (e.g., with respect to SKU and customer segment). Display 600c may additionally include a plurality of natural language explanations 612 of various aspects of the recommendations and/or insights generated using the one or more AI agents and/or process optimization machine learning models (e.g., clustering models, regression models, etc.) used by the AI agents. The natural language explanations 612 may be generated using a large language model (LLM) included in or accessible by the one or more AI agents, and may enable enhanced user understanding of the recommendations and enterprise process insights.

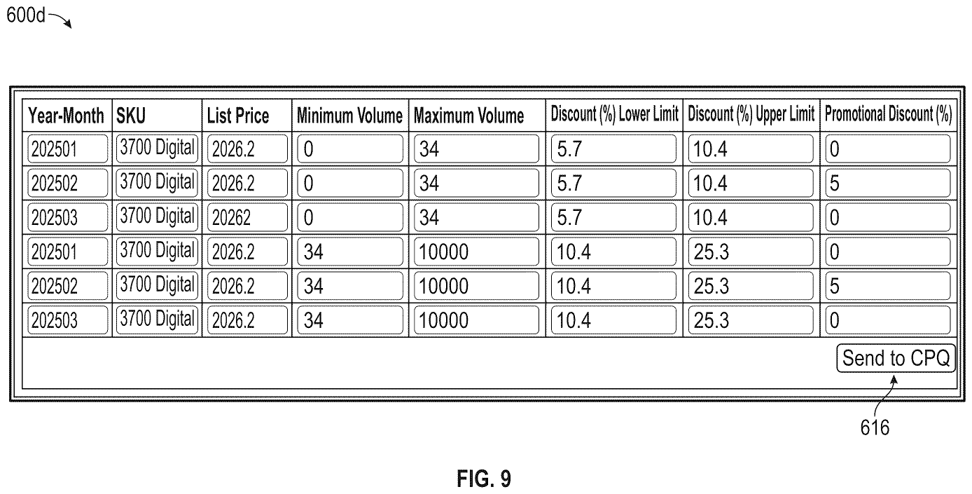

Display 600c may additionally enable a user to deploy one or more of the recommendations generated using the one or more AI agents. For instance, display 600c may include an interactive icon 614 that enables users to deploy recommended pricing adjustments (e.g., to adjust pricing for products and services in the “real-world”). Selection of icon 614 may cause GUI screen 600 to display a deployment screen 600d, an example of which is shown in FIG. 9. Deployment screen 600d may display particular pricing adjustments for one or more SKUs and may enable a user to execute the pricing adjustments for real-world products and services, for instance, by selecting interactive icon 616. Thus, the systems and methods disclosed herein not only provide recommendations but also enable seamless execution of such recommendations (e.g., automatically using AI agents and/or in response to user inputs).

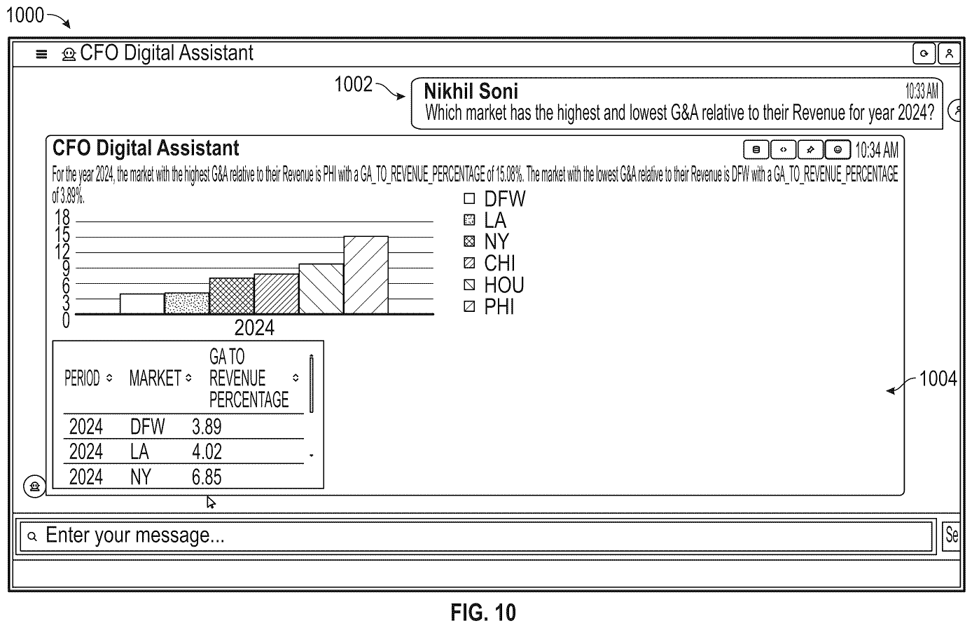

As described throughout, the systems and methods disclosed herein may enable a natural language interface with one or more of the AI agents. FIG. 10 illustrates exemplary aspects of a natural language interface 1000 and an exemplary response generated based on a user-provided natural language prompt 1002. As illustrated in FIG. 10, the user prompt requests “Which market has the highest and lowest G&A relative to their Revenue for year 2024.” As described with reference to process 200, one or more AI agents may process the input prompt to determine a user intent. Based on the determined user intent, the one or more AI agents may leverage a large language model (LLM) to generate an output 1004 responsive to the user prompt.

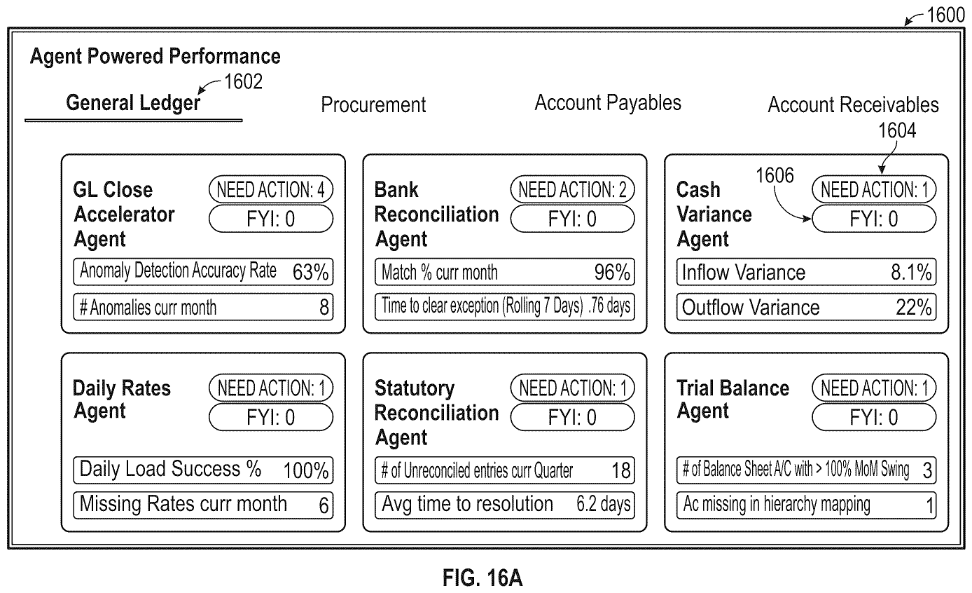

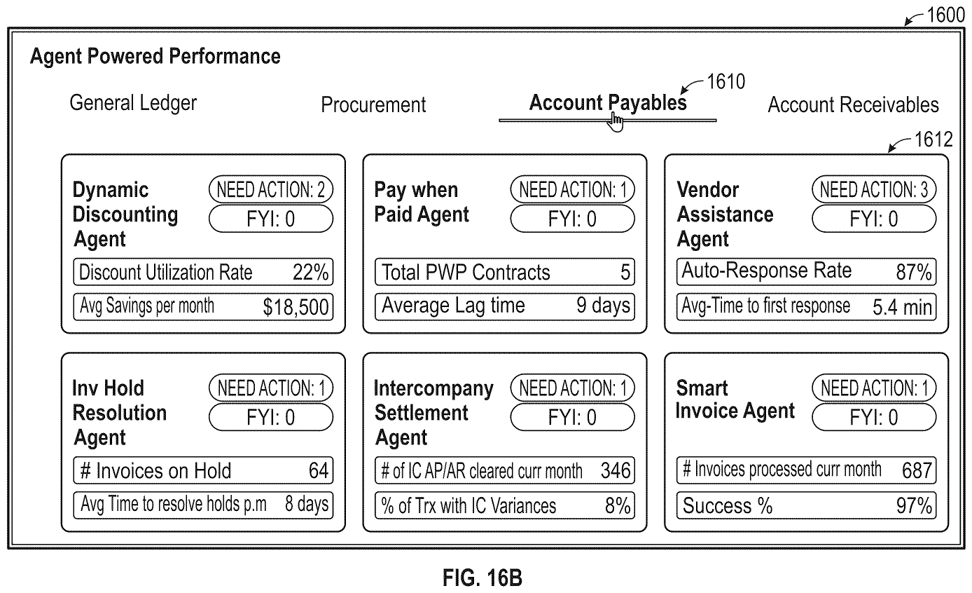

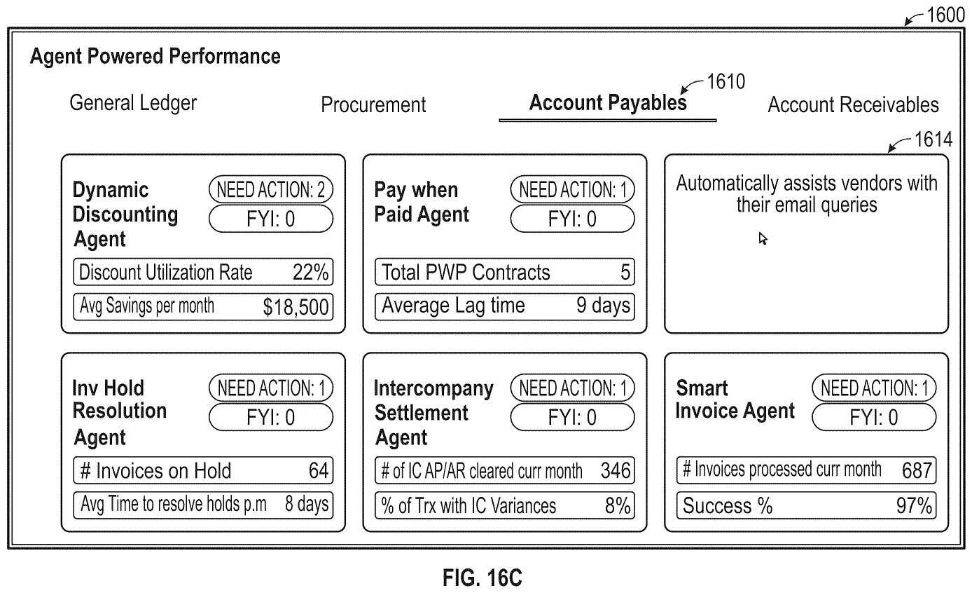

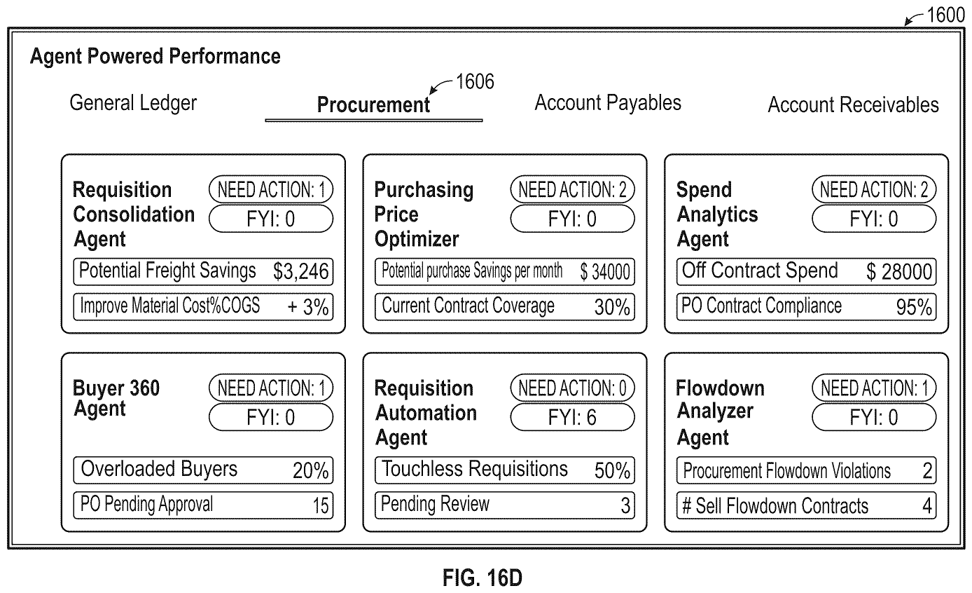

In some examples, system 100 includes an AI agent performance dashboard that may function as a command center for coordinating interactions between human users and AI agents. FIGS. 16A-16D illustrate aspects of an exemplary agent performance dashboard 1600 configured to provide insights into AI-driven performance metrics, items requiring user input, actions taken by the AI agents, and other operational insights. The agent performance dashboard 1600 may be implemented as part of user interface 108 and may be dynamically updated based on outputs of one or more AI agents 114.

As shown in FIG. 16A, the agent performance dashboard 1600 may include a general ledger page 1602 configured to provide insights into matters handled by AI agents associated with general ledger items (e.g., journal entries, reconciliations, and other general ledger processes). The general ledger page 1602 may present, for example, metrics indicating a volume of tasks autonomously handled by AI agents, exception rates, and items requiring human review.

The general ledger page 1602 may include one or more selectable icons 1604 configured to enable a user to access actionable items that a respective AI agent has identified as requiring user inputs. In some examples, the system may be configured such that certain classes of actions (e.g., creating purchase orders, modifying accounting entries above a threshold value, or processing transactions for new counterparties) require a human user's approval. Selecting icon 1604 may cause user interface 108 to display a list or queue of such items, along with context generated by the AI agent (e.g., underlying data, recommended next actions, and confidence scores).

The agent performance dashboard 1600 may include one or more selectable icons 1606 configured to enable a user to access information associated with actions taken by a respective AI agent. For instance, upon selection of icon 1606, user interface 108 may present a log of autonomous or semi-autonomous actions executed by the AI agent (e.g., vendor invoice triage, automatic responses to supplier inquiries, automated application of payment terms), including timestamps, source data, and outcome metrics. In some examples, this action history may support auditability and explainability of AI-driven processes.

As shown in FIGS. 16B and 16C, the agent performance dashboard 1600 may additionally include an accounts payable page 1610 configured to provide insights into matters handled by AI agents associated with accounts payable items (e.g., invoice classification, vendor query responses). The accounts payable page 1610 may present an overview of in-progress tasks, success rates, and open items that require human intervention, similar to the general ledger page 1602. The agent performance dashboard 1600 may further include an AI agent affordance 1612 configured such that, when selected, a user is presented with a description 1614 of the function of the respective AI agent. For example, description 1614 may specify the types of processes the AI agent is authorized to handle, its decision boundaries, and its escalation rules (e.g., thresholds that trigger a request for human input). The description 1614 may be provided by a user or dynamically generated or updated based on configuration data stored in database 102 and/or based on learned behavior of the AI agent over time.

In some examples, the agent performance dashboard 1600 may also include a procurement page 1614 configured to provide insights into matters handled by AI agents associated with procurement items (e.g., purchase requisitions, purchase orders, supplier onboarding, and contract-related workflows). The procurement page 1614 may expose, via interface controls analogous to icons 1604 and 1606, both a queue of items where the procurement-focused agents require human support and a history of actions autonomously taken by those agents. By consolidating multiple function-specific pages (e.g., general ledger page 1602, accounts payable page 1610, procurement page 1614) into agent performance dashboard 1600, the system may provide a “command center” in which humans act as orchestrators overseeing a hybrid workforce of humans and AI agents. It will be understood that additional and/or different pages and other aspects (e.g., an accounts payable page) may be included in the agent performance dashboard 1600.

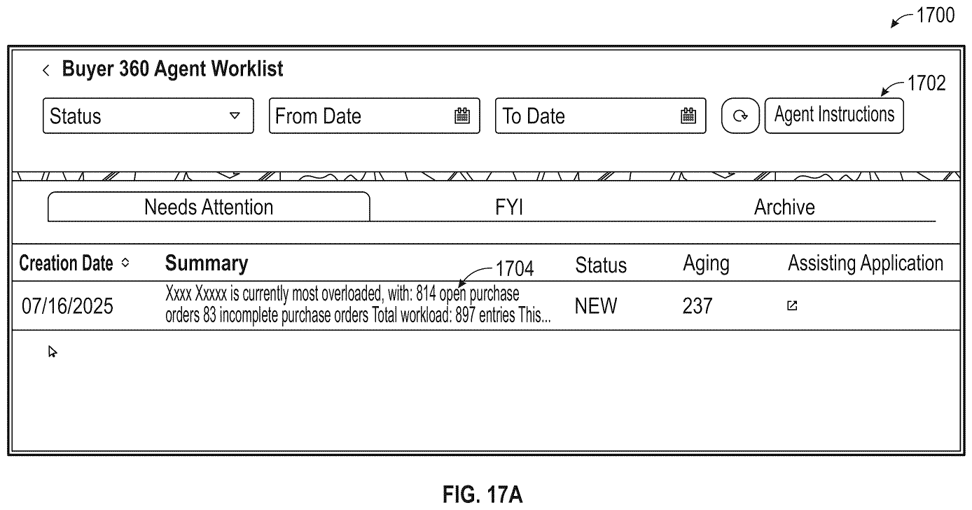

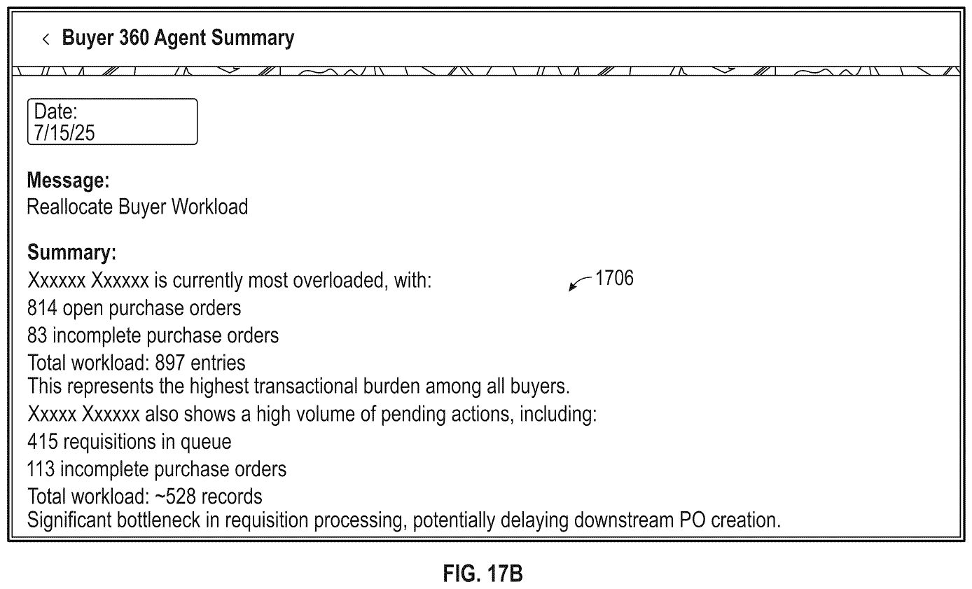

FIGS. 17A and 17B illustrate aspects of a buyer-focused agent dashboard 1700, which may serve as a specialized view within user interface 108 for a “buyer 360” AI agent responsible for supporting procurement or purchasing-related activities. The buyer 360 agent may be one of the AI agents 114 and may leverage process optimization machine learning models 114a, generative AI models 116, and/or other optimization models (e.g., system dynamics models) to propose and/or execute purchasing strategies, supplier communications, and related workflows.

The buyer 360 agent dashboard 1700 may include an agent instructions affordance 1702 configured to enable a user to access modifiable AI agent instructions for the buyer 360 agent. Selection of the agent instructions affordance 1702 may cause user interface 108 to display a panel containing configurable policies, guardrails, or objectives for the agent. For example, the agent instructions may specify maximum allowable unit prices, preferred suppliers, target service-level thresholds, approval thresholds for autonomous purchase order creation, or rules regarding when to escalate to a human user.

The buyer 360 agent dashboard 1700 may further include a selectable summary affordance 1704 configured to enable a user to access a summary of actions taken, outstanding action items, and other status indicators associated with the buyer 360 agent. When the summary affordance 1704 is selected, user interface 108 may present a summary, such as the example summary 1706 shown in FIG. 17B. The summary 1706 may describe, for instance, purchase requests processed during a given period, purchase orders created or amended, supplier exceptions raised, recommended opportunities for consolidation of spend, and items currently pending human approval.

In some examples, the buyer 360 agent may automatically update the summary 1706 based on log data associated with AI-driven procurement processes, such as those described above with reference to procurement-related process optimization machine learning models 114a. The summary 1706 may be generated or augmented using one or more generative AI models 116 to provide natural language explanations of the buyer 360 agent's activities, rationales, and expected impact on performance metrics (e.g., cost savings, cycle-time reduction, or supplier performance).

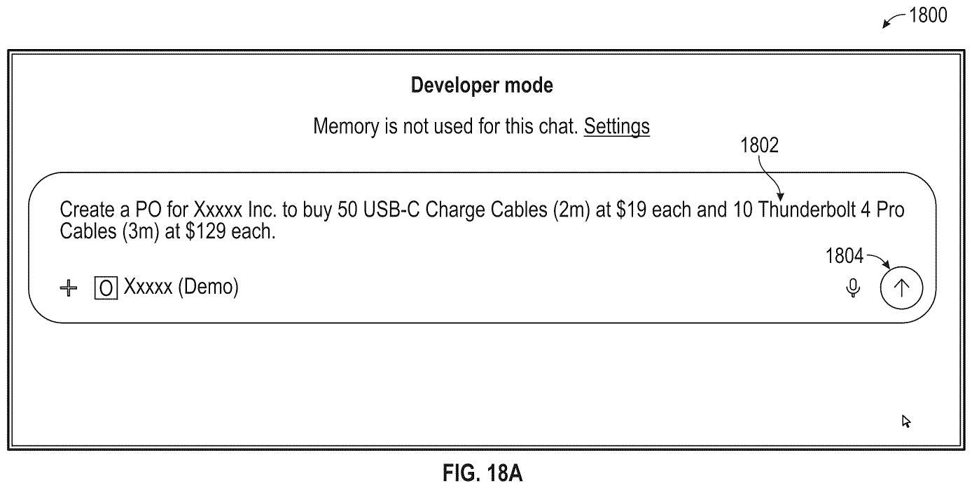

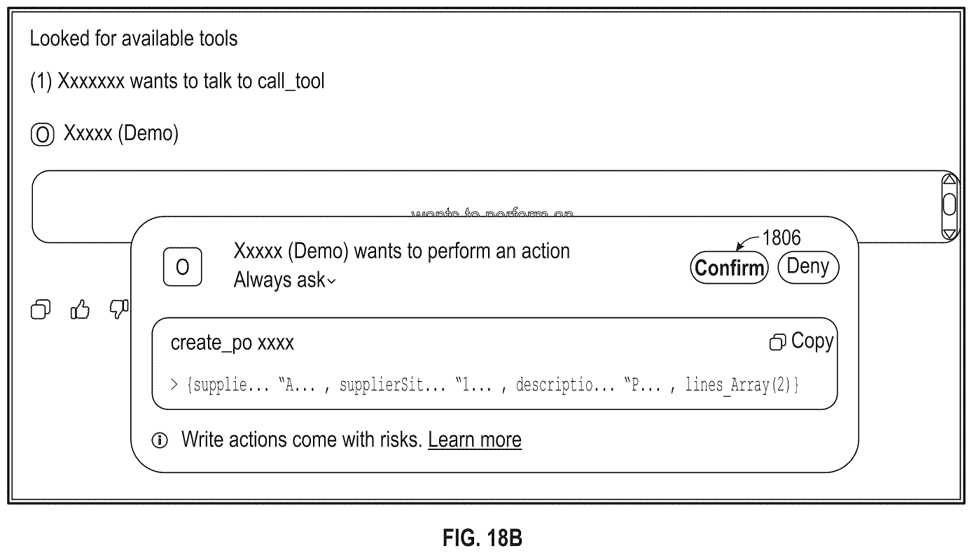

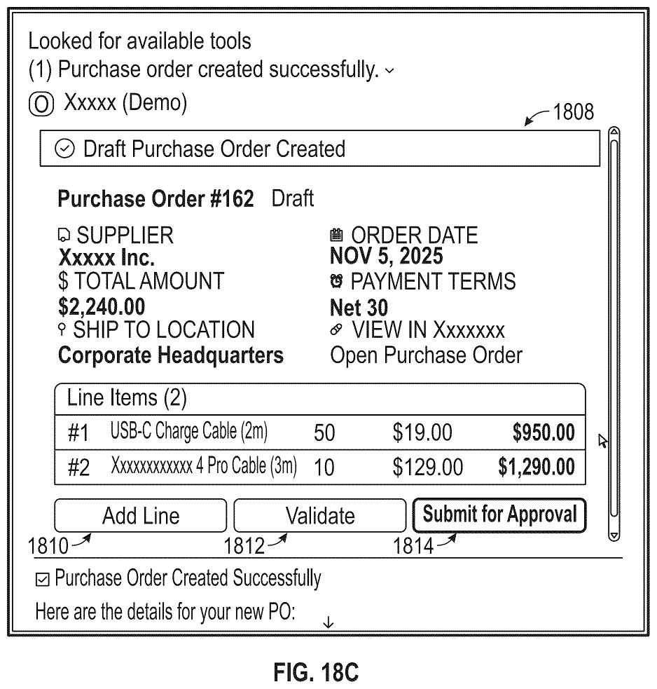

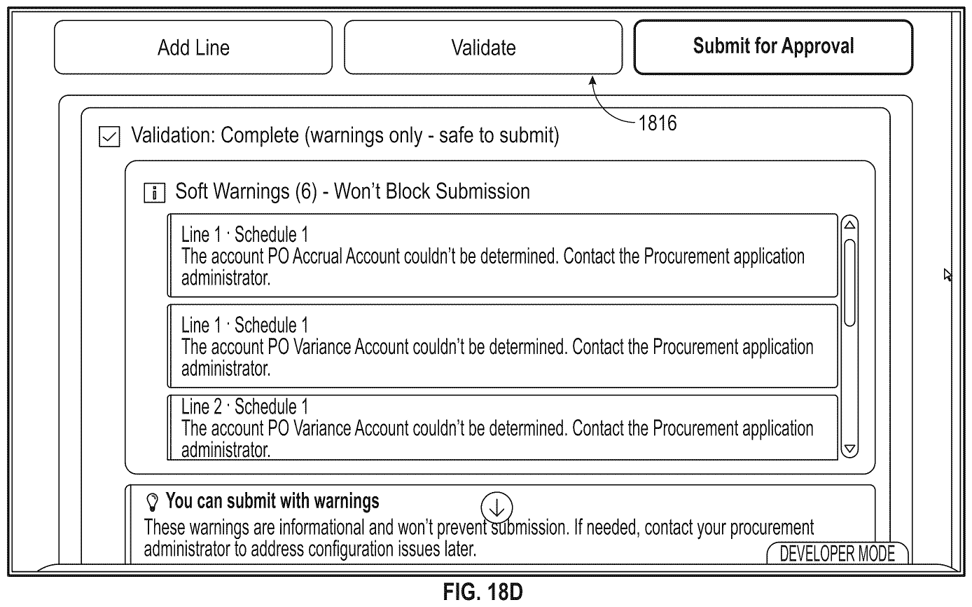

In some examples, system 100 further includes a gateway interface that enables human users to initiate and manage enterprise processes/actions (e.g., transactions) through natural language interactions with one or more AI agents, optionally without directly navigating underlying enterprise applications. This gateway interface may complement the “sense, think, act” framework described herein. In particular, while many “act” operations may be initiated autonomously by AI agents in response to detected process opportunities, certain actions may still be initiated by human users. The gateway interface may provide a natural language interface for controlling, initiating, modifying, etc., such user-initiated actions, allowing users to create and modify actions (e.g., transactions), validate them for hard blocks and soft warnings, and submit them for approval, all from a conversational interface (e.g., instead of or in addition to native ERP screens). FIGS. 18A-18D illustrate aspects of a user interface 1800 for prompting AI agents to execute such enterprise transactions and for validating AI-generated outputs (e.g., purchase orders) prior to submission. It will be understood that a transaction may refer to any enterprise action, process, etc.

As shown in FIG. 18A, user interface 1800 may include an input region 1802 configured to receive user inputs, such as natural language prompts, from a user. For example, a user may enter prompts such as “Create a purchase order to buy cables,” “Add chargers to that purchase order,” “Validate and submit this purchase order,” or “Show me my open purchase orders for a given supplier.” The input region 1802 may be embedded in a conversational front end (e.g., a chat-style interface presented in a browser or collaboration platform), and text entered into input region 1802 may be processed by one or more generative AI models 116 to determine user intent and extract structured parameters (e.g., item descriptions, quantities, supplier constraints, requested dates, report filters) for the requested workflow. In some examples, the gateway may support multiple workflow types, including transaction initiation (e.g., purchase order creation), transaction modification (e.g., adding line items), validation and submission flows, and information retrieval (e.g., listing open purchase orders), with AI agents selecting the appropriate workflow based on the parsed intent.

User interface 1800 may include a selectable affordance 1804 configured to enable a user to submit a prompt entered into input region 1802. Upon selection of affordance 1804, the system may cause one or more AI agents 114 to (i) parse the natural language input, (ii) determine whether the user is requesting a new transaction, an update to an existing transaction, retrieval of information, and/or other action, and (iii) route the request to an appropriate backend connector. In some examples, the AI agents 114 may route the request to a middleware or connector platform (e.g., a Model Context Protocol (MCP) server or other intermediary service) that exposes application programming interfaces (APIs) to one or more ERP systems or other SaaS endpoints 110. The MCP server may determine, based on the parsed intent and context, which backend system and which workflow to invoke (e.g., purchase-order creation versus reporting). The AI agents 114 may thus orchestrate dynamic “tool calls” to the relevant backend systems, based on the parsed intent, without requiring the user to directly log into those systems.

In some examples, user interface 1800 further includes a selectable affordance 1806 configured to solicit user input providing an AI agent with permission to perform a particular action (e.g., creating or updating a purchase order, submitting a transaction for approval, or triggering a report) in the underlying enterprise system, for instance, as shown in FIG. 18B. This affordance 1806 may be surfaced after the AI agent has constructed a proposed transaction object or retrieved a set of records using enterprise data obtained from one or more data sources 104 via the connector platform. Selection of affordance 1806 may constitute human-in-the-loop oversight over AI agents, consistent with a “hybrid workforce” pattern in which AI agents perform first-chair execution work but certain act-phase steps (for example, committing a transaction above a threshold value or for a new counterparty) remain gated on explicit user approval.

FIG. 18C illustrates an example output 1808 generated using user interface 1800 in response to a natural language prompt requesting initiation of a purchase order. In the illustrated example, output 1808 may be a proposed purchase order generated by an AI agent based on the user's request and on enterprise data retrieved from one or more data sources 104 (e.g., approved supplier lists, item catalogs, contract pricing, budget and account coding data). The proposed purchase order 1808 may include fields such as a supplier identifier, header information, individual line items, quantities, prices, tax and freight details, and internal accounting distributions. The gateway interface 1800 may render this information in a compact view linked to the conversational context so that the user can confirm, correct, or augment the AI-generated values without navigating multiple underlying ERP screens.

User interface 1800 may include a selectable add line item affordance 1810 configured to enable a user to add additional items to the AI-generated purchase order 1808. For example, after seeing the proposed purchase order 1808, the user may issue a natural language instruction such as “also add chargers” and/or activate affordance 1810 to add an additional line. Activation of affordance 1810 may cause the system to present additional input controls (e.g., item search, free-text line descriptions, quantity and price fields) and to update the proposed purchase order 1808 accordingly. In some examples, the AI agent may use process optimization machine learning models 114a and/or tools 114c to propose default values for such added line items (for example, suggesting an approved supplier and contract price for the requested item), further reducing the amount of manual interaction required from the user.

User interface 1800 may also include a selectable validation affordance 1812 configured such that, when selected, a validation process is executed to validate the AI agent output (e.g., the purchase order 1808). In some examples, activation of validation affordance 1812 prompts the AI agent to invoke one or more validation services exposed by ERP or SaaS endpoints 110 through the connector platform, checking the proposed transaction against applicable business rules. These checks may include, for example, detection of “hard blocks” (e.g., disallowed or blocked suppliers, items that cannot be ordered, budget violations, missing required fields) and “soft warnings” (e.g., non-preferred suppliers, non-standard payment terms, or deviations from typical price bands), analogous to the hard-block and soft-warning behavior that would occur were the same transaction entered through native ERP screens. The validation process may therefore run in the same back-office systems that validate manually entered transactions, but is triggered and summarized via the gateway interface 1800.

As shown in FIG. 18D, the validation process may generate a validation output 1816 presented to the user. The validation output 1816 may indicate, for each identified condition, whether it is a hard block or a soft warning and may provide explanations and suggested remediations (e.g., “Select an approved vendor,” “Contact the procurement application administrator,” “Adjust quantity to remain within budget,” or “You may proceed, but this price is outside a contracted range”). In some examples, soft warnings allow the user to proceed while acknowledging the warnings, whereas hard blocks may prevent submission until resolved. The AI agent may leverage generative AI models 116 to translate low-level error codes or system messages returned by the backend ERP or SaaS endpoints 110 into user-friendly explanations that can be displayed inline in the conversational interface.

User interface 1800 may further include a selectable submission affordance 1814 configured such that, when selected, the AI-generated and validated output (e.g., purchase order 1808) is submitted for approval and/or execution in an underlying enterprise system. Upon activation of affordance 1814, system 100 may automatically establish or reuse a network communication link with a computing system hosting the relevant enterprise application (e.g., a cloud platform 118 or on-premises ERP instance) and transmit an indication of the finalized transaction, as described with reference to block 222 of process 200C and block 1508 of process 1500. In some examples, the same gateway interface 1800 also supports retrieval workflows in which the user issues a natural language command such as “show my open purchase orders,” and the AI agents 114, via the connector infrastructure, obtain and present a list of open transactions within the conversational interface, enabling the user to filter, sort, and drill down into individual transactions from one interaction layer. In this manner, the gateway interface 1800 operationalizes the sense, think, act paradigm for human-initiated, previously manual actions by providing an AI-enabled, orchestrated, and user-friendly way of executing and managing enterprise transactions that would otherwise require manual navigation of complex enterprise applications.

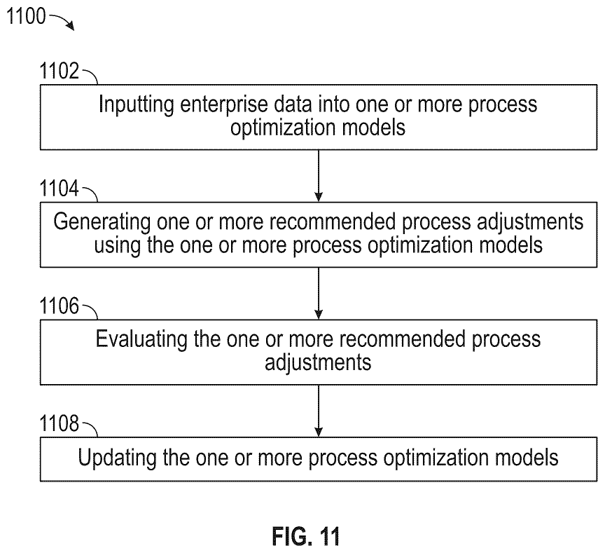

FIG. 11 illustrates aspects of an exemplary process 1100 for training one or more process optimization machine learning models. Process 1100 is performed, for example, using one or more electronic devices implementing a software platform. In some examples, process 1100 is performed using a client-server system, and the blocks of process 1100 are divided up in any manner between the server and a client device. In other examples, the blocks of process 1100 are divided up between the server and multiple client devices. Thus, while portions of process 1100 may be described herein as being performed by particular devices of a client-server system, it will be appreciated that process 1100 is not so limited. In other examples, process 1100 is performed using only a client device or only multiple client devices. In process 1100, some blocks are, optionally, combined, the order of some blocks is, optionally, changed, and some blocks are, optionally, omitted. In some examples, additional steps may be performed in combination with the process 1100. Accordingly, the operations as illustrated (and described in greater detail below) are exemplary by nature and, as such, should not be viewed as limiting.

At block 1102, an exemplary system may input enterprise data into one or more process optimization models. At block 1104, the one or more process optimization models may generate one or more recommended process adjustments. At block 1106, the exemplary system (or a human administrator) may evaluate the one or more recommended process adjustments generated by the one or more process optimization models. At block 1108, the exemplary system may update the one or more process optimization models based on the evaluation. The one or more process optimization models may include aspects of any of the process optimization models disclosed herein.

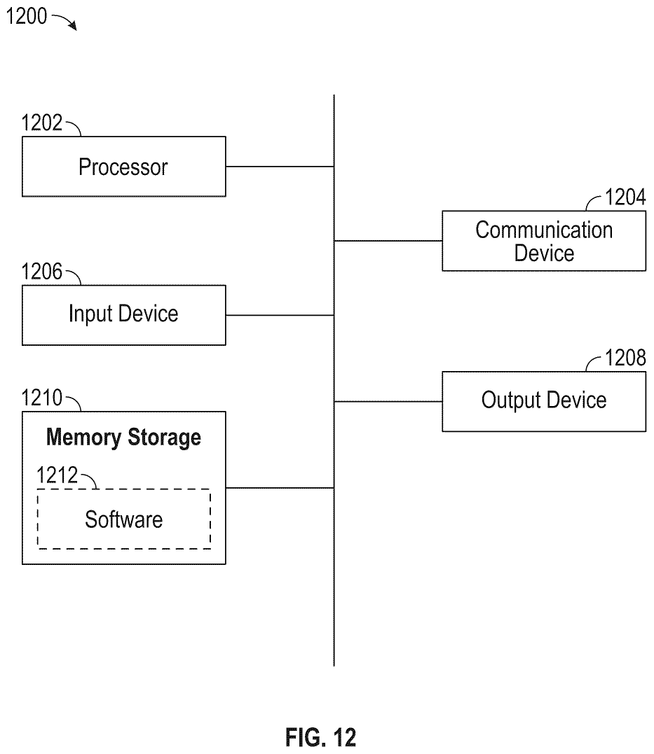

FIG. 12 depicts an exemplary computing device 1200, that may be utilized in accordance with one or more examples of the disclosure. Device 1200 can be a host computer connected to a network. Device 1200 can be a client computer or a server. As shown in FIG. 12, device 1200 can be any suitable type of microprocessor-based device, such as a personal computer, workstation, server, or handheld computing device (portable electronic device) such as a phone or tablet. The device can include, for example, one or more of processors 1202, input device 1206, output device 1208, storage 1210, and communication device 1204. Input device 1206 and output device 1208 can generally correspond to those described above and can either be connectable or integrated with the computer.

Input device 1206 can be any suitable device that provides input, such as a touch screen, keyboard or keypad, mouse, or voice-recognition device. Output device 1208 can be any suitable device that provides output, such as a touch screen, haptics device, or speaker.

Storage 1210 can be any suitable device that provides storage, such as an electrical, magnetic, or optical memory, including a RAM, cache, hard drive, or removable storage disk. Communication device 1204 can include any suitable device capable of transmitting and receiving signals over a network, such as a network interface chip or device. The components of the computer can be connected in any suitable manner, such as via a physical bus or wirelessly.

Software 1212, which can be stored in storage 1210 and executed by processor 1202, can include, for example, the programming that embodies the functionality of the present disclosure (e.g., as embodied in the devices as described above).

Software 1212 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1210, that can contain or store programming for use by or in connection with an instruction execution system, apparatus, or device.

Software 1212 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1200 can implement any operating system suitable for operating on the network. Software 1212 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

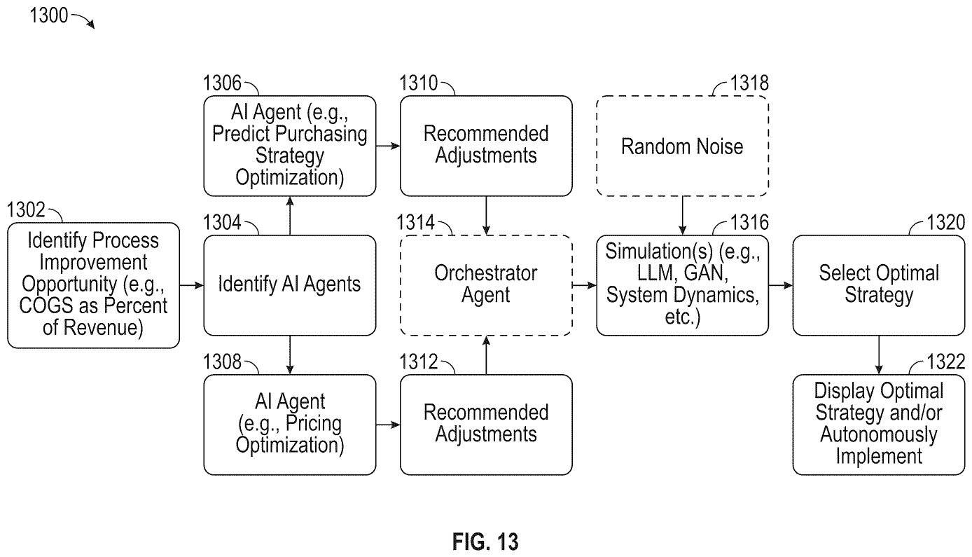

FIG. 13 illustrates a block diagram representing an exemplary process 1300 for simulating and optimizing one or more enterprise processes. Process 1300 is performed, for example, using one or more electronic devices implementing a software platform. In some examples, process 1300 is performed using a client-server system, and the blocks of process 1300 are divided up in any manner between the server and a client device. In other examples, the blocks of process 1300 are divided up between the server and multiple client devices. Thus, while portions of process 1300 may be described herein as being performed by particular devices of a client-server system, it will be appreciated that process 1300 is not so limited. In other examples, process 1300 is performed using only a client device or only multiple client devices. In process 1300, some blocks are, optionally, combined, the order of some blocks is, optionally, changed, and some blocks are, optionally, omitted. In some examples, additional steps may be performed in combination with the process 1300. Accordingly, the operations as illustrated (and described in greater detail below) are exemplary by nature and, as such, should not be viewed as limiting.

At block 1302, an exemplary system may identify a process improvement opportunity. For instance, the system may identify that cost of goods sold can be improved (e.g., reduced) as a percentage of revenue and/or may identify that any other enterprise process is performing below a respective performance criteria (e.g., as described throughout). At block 1304, the system may identify one or more AI agents (or process optimization models) suited for optimizing cost of goods sold as a percentage of revenue. The system may identify one or more AI agents suitable for the process improvement opportunity using an orchestrator AI agent. For instance, the orchestrator AI agent may transmit context associated with the process improvement opportunity to one or more AI agents in the system and the one or more AI agents may compare the context associated with the process improvement opportunity to their own context (e.g., a natural language description of problems for which they are suited) to determine if they are suited for the process improvement opportunity. If the context of the process improvement opportunity corresponds to the context of one or more of the AI agents, then those one or more AI agents may respond to the orchestrator agent. For example, in the illustrated example, the system identified AI Agent 1306 and AI Agent 1308, each of which may have been identified by an orchestrator AI agent based on their context.

The system may input data associated with the process improvement opportunity into the one or more identified AI agents (e.g., AI agent 1306 and AI agent 1308), and the one or more identified AI agents may process the input data to generate one or more recommended process adjustments, including recommended adjustments 1310 and recommended adjustments 1312, respectively, to enterprise processes, for instance, using one or more of the process optimization models disclosed herein. As an example, AI agent 1306 may be a purchasing strategy AI agent and may generate one or more recommended purchasing strategy adjustments. AI agent 1308 may be a pricing optimization AI agent and may generate one or more recommended adjustments to pricing strategy (e.g., by clustering customer segments, determining pricing elasticity for each segment, determining optimal pricing for each segment). In some examples, the one or more AI agents generate recommended an amount/degree of adjustment for one or more processes (e.g., increase pricing by x percent for y product).

The recommended adjustments 1310 and 1312 generated by the one or more identified AI agents (e.g., AI agent 1306 and 1308) may be input into one or more enterprise process simulations. The enterprise process simulations may include generative-AI-based simulations (e.g., constructed and/or executed using LLMs, GANs, etc.), system dynamics simulations, and/or AI agent-based simulations, which may leverage both generative AI and system dynamics modeling. System dynamics simulations may include causal loop simulations and/or other system dynamics simulations for modeling behavior of complex systems over time. In some examples, the recommended adjustments 1310 and 1312 are input into the one or more enterprise process simulations by the orchestrator AI agent, which may select an appropriate simulation and/or generative AI model for the simulation based on, for instance, the context of the process improvement opportunity, the context of the identified AI agent(s), and/or the recommended adjustments. In examples, where the enterprise process simulation uses a GAN model, an input to the enterprise process simulation may include random noise 1318. In some examples, the generative AI simulations are constructed and/or executed using a large language model (LLM), generative adversarial network (GAN), and/or other generative AI model.

The output of the enterprise process simulation may include predicted outcomes (e.g., market/customer reactions, profits, plant operating efficiencies, etc.) based on the simulated adjustments and/or other data input into to the simulations. In some examples, the enterprise process simulation simulates a plurality of combinations of recommended adjustments generated using the one or more identified AI agents. For instance, the enterprise process simulation may simulate a range of pricing strategy adjustments and a range of purchasing strategy adjustments both individually and in combination with one another. The system may output predicted outcomes for each adjustment in the ranges individually and/or combination with each other. Thus, the system enables evaluation of many different variations of process adjustments to multiple different processes (e.g., separately and in combination with one another). The system may select the optimal strategy (e.g., set of one or more adjustments, such as to pricing and/or purchasing in the illustrated example) at block 1320. In the illustrated example, the optimal strategy may be the one that minimizes COGS as a percentage of revenue, but it should be understood that any enterprise process/metric may be targeted using process 1300. At block 1322, the system may display the optimal strategy and/or may autonomously implement the optimal strategy. For instance, one or more AI agents may autonomously execute the optimal strategy within a computing system, deploy the strategy to a cloud computing platform, etc.

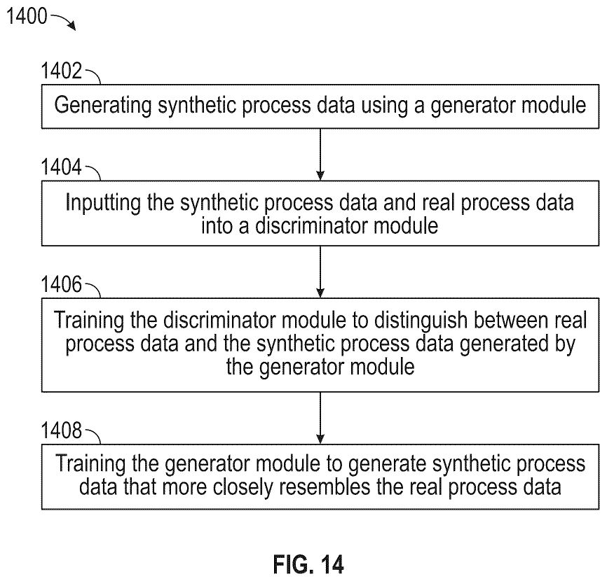

FIG. 14 illustrates an exemplary method 1400 for training a generative adversarial network (GAN) according to some examples. At block 1402, the method may include generating synthetic process data using a generator module of the GAN. At block 1404, the method may include inputting the synthetic process data and real process data into a discriminator module of the GAN. At block 1406, the method may include training the discriminator module to distinguish between real process data and the synthetic process data generated by the generator module. At block 1408, the method may include training the generator module to generate synthetic process data that more closely resembles the real process data. Once the GAN is trained, the system may input hypothetical business parameters (e.g., enterprise process parameters), including recommended strategies/adjustments generated using the process optimization machine learning models into the generator of the GAN, optionally along with random noise. The generator module of the GAN may output a simulated market or client reaction that reflects the patterns learned from historical data. This process may be useful for exploring potential outcomes under various scenarios and may ensure enterprises are not caught by a “black swan” kind of an event or reaction by a supplier/client.

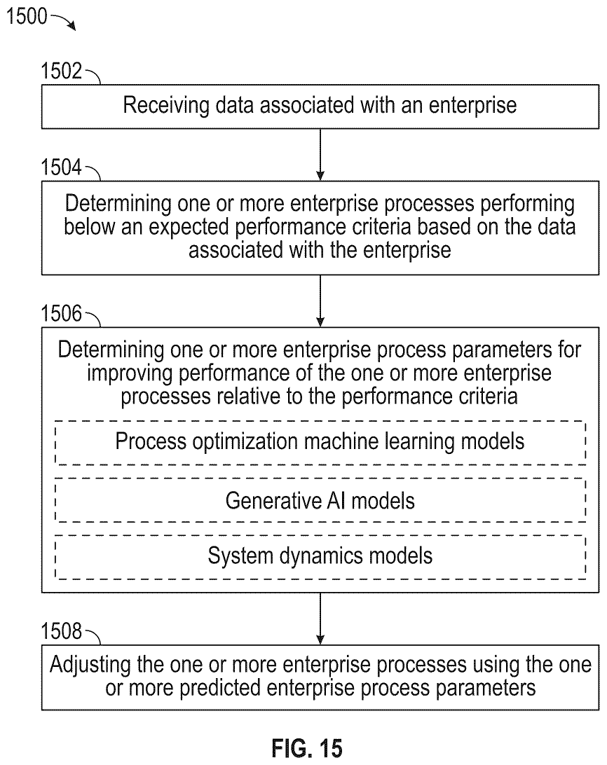

FIG. 15 illustrates an exemplary process 1500 for optimizing one or more enterprise processes. Process 1500 may be implemented using any of the aspects of system 100 described above and may include any of the aspects of processes 200A-200C, process 1100, process 1300, and/or process 1400. Process 1500 is performed, for example, using one or more electronic devices implementing a software platform. In some examples, process 1500 is performed using a client-server system, and the blocks of process 1500 are divided up in any manner between the server and a client device. In other examples, the blocks of process 1500 are divided up between the server and multiple client devices. Thus, while portions of process 1500 may be described herein as being performed by particular devices of a client-server system, it will be appreciated that process 200 is not so limited. In other examples, process 1500 is performed using only a client device or only multiple client devices. In process 1500, some blocks are, optionally, combined, the order of some blocks is, optionally, changed, and some blocks are, optionally, omitted. In some examples, additional steps may be performed in combination with the process 1500. Accordingly, the operations as illustrated (and described in greater detail below) are exemplary by nature and, as such, should not be viewed as limiting.

At block 1502, an exemplary system may receive data associated with an enterprise. The received data may include any of the data described with reference to the systems and methods disclosed herein (e.g., the data ingested from data sources 104 of system 100, the data ingested at block 202 of process 200A, etc.). The data may include data internal to the enterprise and/or data external to the enterprise (e.g., industry data). At block 1504, the exemplary system may determine one or more enterprise processes performing below an expected performance criteria based on the data associated with the enterprise. The performance criteria may include any of those described herein (e.g., with reference to system 100, process 200A-200C, etc.). In some examples, the expected performance criteria comprises one or more predicted future performance metrics.

At block 1506, the exemplary system may predict one or more enterprise process parameters for improving performance of the one or more enterprise processes relative to the performance criteria. The process parameters may correspond to any enterprise process, including those described herein, such as pricing, maintenance, procurement, inventory, purchasing, etc. Determining the one or more enterprise process parameters may include applying one or more modeling techniques selected from the group comprising: one or more process optimization machine learning models, one or more generative AI models, and one or more system dynamics models. The one or more process optimization machine learning models may include any of the process optimization machine learning models described herein (e.g., with reference to process optimization machine learning models 114a, the process optimization machine learning models implemented according to process 200A-200C, process 1300, etc.). In some examples, each of the one or more process optimization machine learning models have been trained using data associated with the enterprise. The one or more generative AI models may include any of the generative AI models described herein, including generative AI models 116 of system 100, the generative AI models implemented according to process 200A-200C, process 1300, process 1400, etc. System dynamics models may include, for instance, causal loop models for predicting the behavior (e.g., nonlinear) behavior of complex systems, such as enterprises, their customers, etc. In some examples, the one or more modeling techniques are selected using an orchestrator AI agent.

In some examples, the system predicts the one or more enterprise process parameters based on a user input comprising an instruction to improve the one or more enterprise processes performing below an expected performance criteria. In some examples, the user input comprises a natural language input. In some examples, the system determines a user intent based on the natural language input using one or more natural language processing models; and selecting the one or more modeling techniques based on the user intent.

In some examples, applying the one or more modeling techniques comprises: determining one or more recommended process parameters using the one or more process optimization machine learning models; and simulating the one or more recommended process parameters using the one or more generative AI models. In some examples, the system outputs a predicted process outcome based on the simulation of the one or more recommended process parameters. In some examples, the system selects an optimal set of one or more process parameters of the one or more recommended process parameters based on the simulation (optionally including a degree to which any adjustment is implemented). In some examples, the one or more generative AI models comprise a large language model (LLM) or a generative adversarial network (GAN).

At block 1508, the exemplary system may adjust the one or more enterprise processes using the one or more predicted enterprise process parameters. Adjusting the one or more enterprise processes may include autonomously adjusting the one or more enterprise processes using one or more AI agents. Adjusting the one or more enterprise processes may include: automatically establishing a network connection with a computing system; and transmitting an indication of the one or more determined enterprise process parameters over the network connection. Adjusting the one or more processes may include automatically adjusting a process parameter stored in a database.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

### Examples

1. A method for optimizing one or more processes using agentic artificial intelligence, the method comprising:
ingesting enterprise data into a database;
executing one or more process optimizations using one or more process optimization models, wherein executing the one or more process optimizations comprises:
   inputting the ingested enterprise data into the one or more process optimization models trained to generate recommended process adjustments,
   outputting one or more recommended process adjustments generated using the one or more process optimization models; and autonomously adjusting the one or more processes based on the one or more recommended process adjustments using one or more AI agents.

2. The method of example 1, comprising:
inputting the one or more recommended process adjustments into a generative AI simulation;
simulating, by the generative AI simulation, one or more processes based on the one or more recommended process adjustments to obtain one or more predicted process outcomes; and
selecting, using one or more AI agents, at least one of the recommended process adjustments based on the one or more predicted process outcomes.

3. The method of any one of examples 1-2, comprising: identifying one or more process improvement opportunities; and selecting one or more process optimization models for the one or more process optimizations based on the one or more process improvement opportunities.

4. The method of example 3, wherein the one or more process optimization models are selected by an orchestrator AI agent.

5. The method of example 3, wherein the orchestrator AI agent is configured to input the one or more process recommended process adjustments into the generative AI simulation.

6. The method of any one of examples 1-5, comprising: training the one or more process-optimization models using to simulate processes the ingested enterprise data.

7. The method of any one of examples 1-6, wherein one or more processes are autonomously adjusted using one or more AI agents by calling one or more tools, wherein the one or more tools comprise one or more application programming interfaces (APIs), one or more data visualization software, one or more statistical analysis packages, one or more optimization algorithms, or a combination thereof.

8. The method of any one of examples 1-7, comprising executing the one or more process optimizations based on a natural language prompt from a user.

9. The method of any one of examples 1-8, wherein executing the one or more process optimizations comprises:
determining a user intent based on a natural language prompt using the one or more AI agents; and
selecting the one or more process-optimization models based on the user intent.

10. The method of any one of examples 1-9, wherein the one or more process optimizations are executed by one or more AI agents based on one or more identified areas of performance degradation.

11. The method of example 10, wherein the one or more areas of performance degradation are identified based on a comparison between one or more measured performance metrics and one or more threshold performance metrics.

12. The method of example 11, wherein the one or more threshold performance metrics comprise predicted future performance metrics.

13. The method of any one of examples 1-12, wherein adjusting the one or more processes comprises:
automatically establishing a network link communication with a computing system; and
transmitting an indication of a process adjustment to the computing system.

14. The method of any one of examples 1-13, wherein adjusting the one or more processes comprises:
automatically adjusting a process parameter stored in a database.

15. The method of any one of examples 1-14, comprising displaying a predicted process performance metric based on the one or more process simulations on an interactive graphical user interface.

16. The method of any one of examples 1-15, wherein executing the one or more process optimizations comprises:
simulating adjustments to one or more processes using the one or more process-optimization models.

17. The method of any one of examples 1-16, wherein inputting the one or more process recommended process adjustments into a generative AI simulation comprises inputting the one or more process recommended process adjustments into a large language model.

18. The method of any one of examples 1-17, wherein inputting the one or more process recommended process adjustments into a generative AI simulation comprises inputting the one or more process recommended process adjustments into a generator module of a generative adversarial network (GAN).

19. The method of example 18, wherein the GAN has been trained by:
generating synthetic process data using the generator module;
inputting the synthetic process data and real process data into a discriminator module of the GAN;
training the discriminator module to distinguish between real process data and the synthetic process data generated by the generator module; and
training the generator module to generate synthetic process data that more closely resembles the real process data.

20. A system for optimizing one or more processes using agentic artificial intelligence, the system comprising: one or more processors, a memory, and one or more programs, wherein the one or more programs are stored in the memory and configured to be executed by the one or more processors, the one or more programs including instructions for:
ingesting enterprise data into a database;
executing one or more process optimizations using one or more process-optimization models, wherein executing the one or more process optimizations comprises:
   inputting the ingested enterprise data into the one or more process-optimization models trained to generate recommended process adjustments,
   outputting one or more recommended process adjustments generated using the one or more process optimization models,
inputting the one or more process recommended process adjustments into a generative AI simulation;
simulating, by the generative AI simulation, one or more processes based on the one or more recommended process adjustments to obtain one or more predicted process outcomes;
selecting at least one of the recommended process adjustments based on the one or more predicted process outcomes; and
adjusting the one or more processes based on the one or more selected adjustments.

21. A non-transitory computer-readable storage medium storing one or more programs for optimizing one or more processes using agentic artificial intelligence, the one or more programs comprising instructions, which when executed by one or more processors of an electronic device, cause the electronic device to:
ingest enterprise data into a database;
execute one or more process optimizations using one or more process-optimization models, wherein executing the one or more process optimizations comprises:
   inputting the ingested enterprise data into the one or more process-optimization models trained to generate recommended process adjustments,
   outputting one or more recommended process adjustments generated using the one or more process optimization models,
inputting the one or more process recommended process adjustments into a generative AI simulation;
simulate, by the generative AI simulation, one or more processes based on the one or more recommended process adjustments to obtain one or more predicted process outcomes;
select at least one of the recommended process adjustments based on the one or more predicted process outcomes; and
adjust the one or more processes based on the one or more selected adjustments.

22. A method for optimizing one or more enterprise processes, the method comprising:
receiving data associated with an enterprise;
determining one or more enterprise processes performing below an expected performance criteria based on the data associated with the enterprise;
determining one or more enterprise process parameters for improving performance of the one or more enterprise processes relative to the performance criteria, wherein determining the one or more enterprise process parameters comprises:
   applying one or more modeling techniques selected from the group comprising: one or more process optimization machine learning models, one or more generative AI models, and one or more system dynamics models;
adjusting the one or more enterprise processes using the one or more determined enterprise process parameters.

23. The method of example 22, wherein adjusting the one or more enterprise processes comprises autonomously adjusting the one or more enterprise processes using one or more AI agents.

24. The method of any one of examples 22-23, wherein each of the one or more process optimization machine learning models have been trained using data associated with the enterprise.

25. The method of any one of examples 22-24, comprising: selecting the one or more modeling techniques using an orchestrator AI agent.

26. The method of any one of examples 22-25, comprising: receiving a user input comprising an instruction to improve the one or more enterprise processes performing below an expected performance criteria.

27. The method of example 26, wherein the user input comprises a natural language input.

28. The method of example 27, comprising: determining a user intent based on the natural language input using one or more natural language processing models; and selecting the one or more modeling techniques based on the user intent.

29. The method of any one of examples 22-28, wherein applying the one or more modeling techniques comprises:
determining one or more recommended process parameters using the one or more process optimization machine learning models; and
simulating the one or more recommended process parameters using the one or more generative AI models.

30. The method of example 29, comprising: outputting a predicted process outcome based on the simulation of the one or more recommended process parameters.

31. The method of example 30, comprising: selecting an optimal set of one or more process parameters of the one or more recommended process parameters based on the simulation.

32. The method of any one of examples 29-31, wherein the one or more generative AI models comprise a large language model (LLM) or a generative adversarial network (GAN).

33. The method of any one of examples 22-32, wherein the expected performance criteria comprises one or more predicted future performance metrics.

34. The method of any one of examples 22-33, wherein adjusting the one or more enterprise processes comprises:
automatically establishing a network connection with a computing system; and
transmitting an indication of the one or more determined enterprise process parameters over the network connection.

35. The method of any one of examples 22-34, wherein adjusting the one or more processes comprises: automatically adjusting a process parameter stored in a database.

36. A system for optimizing one or more processes, the system comprising: one or more processors, a memory, and one or more programs, wherein the one or more programs are stored in the memory and configured to be executed by the one or more processors, the one or more programs including instructions for:
receiving data associated with an enterprise;
determining one or more enterprise processes performing below an expected performance criteria based on the data associated with the enterprise;
determining one or more enterprise process parameters for improving performance of the one or more enterprise processes relative to the performance criteria, wherein determining the one or more enterprise process parameters comprises:
   applying one or more modeling techniques selected from the group comprising: one or more process optimization machine learning models, one or more generative AI models, and one or more system dynamics models;
adjusting the one or more enterprise processes using the one or more determined enterprise process parameters.

37. A non-transitory computer-readable storage medium storing one or more programs for optimizing one or more processes, the one or more programs comprising instructions, which when executed by one or more processors of an electronic device, cause the electronic device to:
receiving data associated with an enterprise;
determining one or more enterprise processes performing below an expected performance criteria based on the data associated with the enterprise;
determining one or more enterprise process parameters for improving performance of the one or more enterprise processes relative to the performance criteria, wherein determining the one or more enterprise process parameters comprises:
   applying one or more modeling techniques selected from the group comprising: one or more process optimization machine learning models, one or more generative AI models, and one or more system dynamics models;
adjusting the one or more enterprise processes using the one or more determined enterprise process parameters.

38. A method for optimizing one or more processes using agentic artificial intelligence, the method comprising:
ingesting enterprise data into a database;
executing one or more process optimizations using one or more process optimization models, wherein executing the one or more process optimizations comprises:
   inputting the ingested enterprise data into the one or more process optimization models trained to generate recommended process adjustments,
   outputting one or more recommended process adjustments generated using the one or more process optimization models; and
inputting the one or more recommended process adjustments into a generative AI simulation;
simulating, by the generative AI simulation, one or more processes based on the one or more recommended process adjustments to obtain one or more predicted process outcomes; and
selecting, using one or more AI agents, at least one of the recommended process adjustments based on the one or more predicted process outcomes
autonomously adjusting the one or more processes based on the one or more recommended process adjustments using the one or more AI agents.

39. The method of any one of examples 1-19, further comprising:
displaying, on an interactive graphical user interface, an agent performance dashboard configured to present performance metrics and queues of items requiring user input associated with the one or more processes.

40. The method of any one of examples 1-19, further comprising:
receiving, via a conversational user interface, a natural language input requesting initiation of an enterprise action associated with the one or more processes; and
determining, using at least one generative AI model, a user intent and one or more structured parameters for the requested enterprise action based on the natural language input.

41. The method of example 40, wherein the conversational user interface comprises:
an input region configured to receive the natural language input; and
a submit affordance configured to cause the one or more AI agents to process the natural language input and determine a workflow for executing the enterprise action using one or more software-as-a-service endpoints.

42. The method of any one of examples 40-41, comprising:
generating, using the one or more AI agents, a candidate action object comprising one or more fields populated based on enterprise data and the structured parameters; and
rendering an indication of the candidate action object on the conversational user interface.

43. The method of any one of examples 40-42, wherein the conversational user interface comprises:
a permission affordance configured to solicit explicit user approval for the one or more AI agents to perform the enterprise action; and
wherein the one or more AI agents are configured to refrain from submitting the enterprise action for execution until the permission affordance is activated.

44. The method of example 43, comprising: submitting the enterprise action using the one or more AI agents.

1. A method for optimizing one or more processes using agentic artificial intelligence, the method comprising:
ingesting enterprise data into a database;
executing one or more process optimizations using one or more process optimization models, wherein executing the one or more process optimizations comprises:
inputting the ingested enterprise data into the one or more process optimization models trained to generate recommended process adjustments,
outputting one or more recommended process adjustments generated using the one or more process optimization models;
inputting the one or more recommended process adjustments into a generative AI simulation;
simulating, by the generative AI simulation, one or more processes based on the one or more recommended process adjustments to obtain one or more predicted process outcomes; and
selecting, using one or more AI agents, at least one of the recommended process adjustments based on the one or more predicted process outcomes; and
autonomously adjusting the one or more processes based on the one or more recommended process adjustments using one or more AI agents.

2. The method of claim 1, comprising:
identifying one or more process improvement opportunities; and
selecting one or more process optimization models for the one or more process optimizations based on the one or more process improvement opportunities.

3. The method of claim 2, wherein the one or more process optimization models are selected by an orchestrator AI agent.

4. The method of claim 2, wherein the orchestrator AI agent is configured to input the one or more process recommended process adjustments into the generative AI simulation.

5. The method of claim 1, comprising:
training the one or more process-optimization models using to simulate processes the ingested enterprise data.

6. The method of claim 1, wherein one or more processes are autonomously adjusted using one or more AI agents by calling one or more tools, wherein the one or more tools comprise one or more application programming interfaces (APIs), one or more data visualization software, one or more statistical analysis packages, one or more optimization algorithms, or a combination thereof.

7. The method of claim 1, comprising executing the one or more process optimizations based on a natural language prompt from a user.

8. The method of claim 1, wherein executing the one or more process optimizations comprises:
determining a user intent based on a natural language prompt using the one or more AI agents; and
selecting the one or more process-optimization models based on the user intent.

9. The method of claim 1, wherein the one or more process optimizations are executed by one or more AI agents based on one or more identified areas of performance degradation.

10. The method of claim 9, wherein the one or more areas of performance degradation are identified based on a comparison between one or more measured performance metrics and one or more threshold performance metrics.

11. The method of claim 10, wherein the one or more threshold performance metrics comprise predicted future performance metrics.

12. The method of claim 1, wherein adjusting the one or more processes comprises:
automatically establishing a network link communication with a computing system; and
transmitting an indication of a process adjustment to the computing system.

13. The method of claim 1, wherein adjusting the one or more processes comprises:
automatically adjusting a process parameter stored in a database.

14. The method of claim 1, comprising displaying a predicted process performance metric based on the one or more process simulations on an interactive graphical user interface.

15. The method of claim 1, wherein executing the one or more process optimizations comprises:
simulating adjustments to one or more processes using the one or more process-optimization models.

16. The method of claim 1, wherein inputting the one or more process recommended process adjustments into a generative AI simulation comprises inputting the one or more process recommended process adjustments into a large language model.

17. The method of claim 1, wherein inputting the one or more process recommended process adjustments into a generative AI simulation comprises inputting the one or more process recommended process adjustments into a generator module of a generative adversarial network (GAN).

18. The method of claim 17, wherein the GAN has been trained by:
generating synthetic process data using the generator module;
inputting the synthetic process data and real process data into a discriminator module of the GAN;
training the discriminator module to distinguish between real process data and the synthetic process data generated by the generator module; and
training the generator module to generate synthetic process data that more closely resembles the real process data.

19. The method of claim 1, further comprising:
displaying, on an interactive graphical user interface, an agent performance dashboard configured to present performance metrics and queues of items requiring user input associated with the one or more processes.

20. The method of claim 1, further comprising:
receiving, via a conversational user interface, a natural language input requesting initiation of an enterprise action associated with the one or more processes; and
determining, using at least one generative AI model, a user intent and one or more structured parameters for the requested enterprise action based on the natural language input.

21. The method of claim 20, wherein the conversational user interface comprises:
an input region configured to receive the natural language input; and
a submit affordance configured to cause the one or more AI agents to process the natural language input and determine a workflow for executing the enterprise action using one or more software-as-a-service endpoints.

22. The method of claim 20, comprising:
generating, using the one or more AI agents, a candidate action object comprising one or more fields populated based on enterprise data and the structured parameters; and
rendering an indication of the candidate action object on the conversational user interface.

23. The method claim 20, wherein the conversational user interface comprises:
a permission affordance configured to solicit explicit user approval for the one or more AI agents to perform the enterprise action; and
wherein the one or more AI agents are configured to refrain from submitting the enterprise action for execution until the permission affordance is activated.

24. The method of claim 23, comprising: submitting the enterprise action using the one or more AI agents.

25. A system for optimizing one or more processes using agentic artificial intelligence, the system comprising: one or more processors, a memory, and one or more programs, wherein the one or more programs are stored in the memory and configured to be executed by the one or more processors, the one or more programs including instructions for:
ingesting enterprise data into a database;
executing one or more process optimizations using one or more process-optimization models, wherein executing the one or more process optimizations comprises:
inputting the ingested enterprise data into the one or more process-optimization models trained to generate recommended process adjustments,
outputting one or more recommended process adjustments generated using the one or more process optimization models,
inputting the one or more process recommended process adjustments into a generative AI simulation;
simulating, by the generative AI simulation, one or more processes based on the one or more recommended process adjustments to obtain one or more predicted process outcomes;
selecting at least one of the recommended process adjustments based on the one or more predicted process outcomes; and
adjusting the one or more processes based on the one or more selected adjustments.

26. A non-transitory computer-readable storage medium storing one or more programs for optimizing one or more processes using agentic artificial intelligence, the one or more programs comprising instructions, which when executed by one or more processors of an electronic device, cause the electronic device to:
ingest enterprise data into a database;
execute one or more process optimizations using one or more process-optimization models, wherein executing the one or more process optimizations comprises:
inputting the ingested enterprise data into the one or more process-optimization models trained to generate recommended process adjustments,
outputting one or more recommended process adjustments generated using the one or more process optimization models,
inputting the one or more process recommended process adjustments into a generative AI simulation;
simulate, by the generative AI simulation, one or more processes based on the one or more recommended process adjustments to obtain one or more predicted process outcomes;
select at least one of the recommended process adjustments based on the one or more predicted process outcomes; and
adjust the one or more processes based on the one or more selected adjustments.
